(19) United States
(12) Patent Application Publication
(10) Pub. No.: US 2018/0144476 A1
(43) Pub. Date: May 24, 2018

(54) CASCADED-TIME-SCALE BACKGROUND MODELING

(71) Applicant: QUALCOMM Incorporated, San Diego, CA (US)

(72) Inventor: Gregory Smith, Toronto (CA)

(21) Appl. No.: 15/360,227

(22) Filed: Nov. 23, 2016

(51) Int. Cl. G06T 7/00; G06T 7/20; G06K 9/00; G06K 9/62; G06T 3/40

(52) U.S. Cl. CPC G06T 7/0097; G06T 7/2006; G06T 7/204; G06K 9/00744; G06K 9/6202; G06T 5/30; G06T 3/40; G06T 2207/10016; G06T 2207/20144; G06T 2207/20148; G06K 9/6215

(57) ABSTRACT

The techniques and systems described for a cascaded-time-scale background modeling technique. In various implementations, the technique includes maintaining a short-term background model, which can be updated for every input video frame. The technique further includes maintaining a medium-term background model, which updates less frequently than the short-term background model. The medium-term background model updates using the short-term background model, where the short-term background model provides updated pixel values and/or identifies pixel locations in the medium-term background to update. The technique can also include maintaining a long-term background model, which updates less frequently than the medium-term background model. The long-term background model can be updated using a set of medium-term background models, which can indicate which areas of the background are stable and should be updated. Pixel values in these stable areas can be different from the values in the long-term background model, indicating a change to the background.

### FIELD

The present disclosure generally relates to video analytics, and more specifically to techniques and systems for background modeling for background detection and tracking changes in the background of a scene.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. In some cases, video analytics can send alerts or alarms for certain events of interest. More advanced video analytics is needed to provide efficient and robust video sequence processing.

### BRIEF SUMMARY

In some embodiments, techniques and systems are described for background modeling in video analytics. Background extraction refers to the process of analyzing video frames from a fixed camera, over an indefinite time period, to determine pixels associated with the background, or fixed areas of the scene. Background extraction can be used to separate background pixels from foreground pixels. Neighboring foreground pixels can be grouped into blobs. A blob represents at least a portion of one or more objects in a video frame (also referred to as a “picture”). Blobs can be associated with blob trackers, which can track the movement of an object represented by a blob as the object moves within the scene.

One technique for background extraction includes using a Gaussian Mixture Model (GMM) to analyze each pixel in a video frame to determine whether a pixel should be classified as a background pixel or a foreground pixel. While methods that use the Gaussian Mixture Model can produce a detailed and robust model of a background, the detail and robustness can come at the cost of high data and bandwidth usage, and large processing requirements. Methods that use the Gaussian Mixture Model also typically examine each pixel individually, and may not take advantage of spatial correlations between neighboring pixels. Using such correlations can potentially reduce the computational complexity in determining a background model, and potentially also improve the accuracy of the background model.

The Gaussian Mixture Model and other statistical background extraction techniques are also not able to detect changes to a background. Statistical background extraction techniques typically update the background model for every input video frame. Thus, when a moving object stops moving for long enough, the object may be incorporated into the background model. To avoid this situation, the background model can be updated more slowly, but doing so may increase the computation complexity, storage needs, and bandwidth needs for a video analysis system.

The techniques and systems described herein perform a cascaded-time-scale background modeling technique, which can generate accurate background models potentially without increasing the computational complexity required or increasing the amount of memory needed for such computations. The cascaded-time-scale background modeling technique can also produce background models that can be used to identify changes to the background.

In various implementations, the cascaded-time-scale background modeling technique includes maintaining a first background model, referred to as the short-term background model. The short-term background model can be updated for every input video frame, using a simplified statistical background modeling method, such as the Gaussian Mixture Model or other statistical background modeling method. In various implementations, the cascaded-time-scale background modeling technique further includes maintaining a second background model, referred to as the medium-term background model. The medium-term background model updates less frequently than the short-term background model, such as a few times every second or other time period. The medium-term background model updates using the short-term background model, where the short-term background model provides updated pixel values and/or identifies pixel locations in the medium-term background to update.

In some implementations, the cascaded-time-scale background modeling technique further includes maintaining a third background model, referred to as the long-term background model. The long-term background model updates less frequently than the medium-term background model, such as every eight seconds or other time period. In various implementations, the long-term background model is updated using a set of medium-term background models. The set of medium-term background models can indicate which areas of the background have been stable since the previous time the long-term background model was updated. These areas in the long-term background model can be updated, using pixel values from the set of medium-term background models. The set of medium-term background models can also indicate where the background has changed since the long-term background model was last updated. This change can be signaled to the video analysis system, which can use a history of long-term background models to track changes to the background of a scene.

In various implementations, a video analysis system can implement data reduction techniques, which the video analysis system can use to reduce the size of input video frames prior to applying background modeling techniques to the input video frames. Reducing the size of input video frames can reduce the amount of data that is processed in the course of modeling, as well as the amount of memory needed during background modeling processes. Typical data reduction techniques can, however, cause loss of detail in the input video frames. Thus, in various implementations, the data reduction techniques discussed below include adding gradient information to each video frame prior to downscaling the video frame. The gradient information can preserve edges, textures, and small features when a video frame is downscaled. Such details can then be incorporated into a background model. Reduced-size input video frames can also be used by other processes in a video analysis system that operate on input video frames.

According to at least one example, a method for background modeling is provided that includes determining a first background model for a sequence of video frames. The first background model can include values for each pixel location in a video frame from the sequence of video frames. The values for each pixel location can correspond to a background pixel at each pixel location. The method further includes periodically determining a second background model using the first background model. A time interval for periodically determining the second background model can include a set of video frames from the sequence of video frames. The second background model can be determined using one or more values from the first background model. The method further includes using the second background model to extract background pixels from a particular video frame from the sequence of video frames.

In another example, an apparatus is provided that includes a memory configured to store video data and a processor. The processor is configured to and can determine a first background model for a sequence of video frames. The first background model can include values for each pixel location in a video frame from the sequence of video frames. The values for each pixel location can correspond to a background pixel at each pixel location. The processor is configured to and can periodically determine a second background model using the first background model. A time interval for periodically determining the second background model can include a set of video frames from the sequence of video frames. The second background model can be determined using one or more values from the first background model. The processor is configured to and can use the second background model to extract background pixels from a particular video frame from the sequence of video frames.

In another example, a computer readable medium is provided having stored thereon instructions that when executed by a processor perform a method that includes: determining a first background model for a sequence of video frames. The first background model can include values for each pixel location in a video frame from the sequence of video frames. The values for each pixel location can correspond to a background pixel at each pixel location. The method further includes periodically determining a second background model using the first background model. A time interval for periodically determining the second background model can include a set of video frames from the sequence of video frames. The second background model can be determined using one or more values from the first background model. The method further includes using the second background model to extract background pixels from a particular video frame from the sequence of video frames.

In another example, an apparatus is provided that includes means for background modeling. The apparatus further comprises means for determining a first background model for a sequence of video frames. The first background model can include values for each pixel location in a video frame from the sequence of video frames. The values for each pixel location can correspond to a background pixel at each pixel location. The apparatus further comprises means for periodically determining a second background model using the first background model. A time interval for periodically determining the second background model can include a set of video frames from the sequence of video frames. The second background model can be determined using one or more values from the first background model. The apparatus further comprises means for using the second background model to extract background pixels from a particular video frame from the sequence of video frames.

In some aspects, the methods, apparatuses, and computer readable medium described above further comprise determining the second background model by, upon expiration of the time interval, using the second background model to identify foreground pixel locations and background pixel locations in a current video frame. These aspects further include updating the second background model using the identified background pixel locations. The second background model can be updated with values from the first background model that correspond to the background pixel locations.

In some aspects, the methods, apparatuses, and computer readable medium described above further comprise identifying the foreground pixel locations and the background pixel locations by comparing values in the second background model against pixels in the current video frame. The foreground pixel locations can include locations in the current video frame where a result of the comparing is equal to or greater than a difference threshold. The background pixel locations can include locations in the current video frame where the result of the comparing is less than the difference threshold.

In some aspects, the methods, apparatuses, and computer readable medium described above further comprise periodically determining a third background model using a set of the second background model. A second time interval for periodically determining the third background model can include a second set of video frames from the sequence of video frames, where the second set is larger than the set of video frames used to determine the second background model. The third background model can be determined using values determined from the set of the second background model.

In some aspects, determining the third background model can include, upon expiration of the second time interval, using the third background model to identify foreground pixel locations and background pixel locations in a current video frame. In these aspects, updating the third background model can use the identified background pixel locations. The third background model can be updated with values determined from the set of the second background model. The values can be determined for locations that correspond to the background pixel locations.

In some aspects, determining the third background model can include determining, using the set of the second background model, a change status for each pixel location in the third background model. In these aspects, when a degree of change at a pixel location is less than a change threshold, the change status is set to a first value. Additionally, when the degree of change at a pixel location is equal to or greater than the change threshold, the change status is set to a second value. In these aspects, the third background model can be updated using the set of the second background model. The third background model can be updated using values determined from the set of the second model that correspond to pixel locations having a change status set to the first value.

In some aspects, determining the third background model includes grouping neighboring pixel locations that have a same change status. These aspects can further include resetting the change status for ungrouped pixel locations. Ungrouped pixel locations having a change status set to the first value can be reset to having a change status set to the second value. Ungrouped pixel locations having a change status set to the second value can reset to having a change status set to the first value.

In some aspects, determining the third background model can include determining, using the set of the second background model, a change status for each pixel location in the third background model. In these aspects, when a degree of change at a pixel location is less than a change threshold, the change status can be set to a first value. Additionally, when the degree of change at a pixel location is equal to or greater the change threshold, the change status can be set to a second value. These aspects can further include determining to not update the third background model at pixel locations having a change status set to the second value.

In some aspects, the methods, apparatuses, and computer readable medium described above further comprise determining, using the set of the second background model, a change status for each pixel location in the third background model. When a degree of change at a pixel location is less than a change threshold, the change status can be set to a first value. When the degree of change at a pixel location is equal to or greater the change threshold, the change status can be set to a second value. These aspects can further include comparing pixel locations in a current second background model against corresponding pixel locations in the third background model. The compared pixel locations have a change status set to the first value. These aspects can further include determining, using a result of the comparing, that one or more pixel locations vary between the current background model and the third background model by an amount exceeding a similarity threshold. These aspects can further include signaling a change in the third background model.

In some aspects, the methods, apparatuses, and computer readable medium described above further comprise using the third background model to identify a change in the background pixels.

In some aspects, the methods, apparatuses, and computer readable medium described above further comprise maintaining one or more previous versions of the third background model. These aspects can further include use the one or more previous versions to identify a change in the background pixels.

In some aspects, the methods, apparatuses, and computer readable medium described above further comprise reducing a size of a video frame from the sequence of video frames. These aspects can further include using the reduced-size video frame to determine the first background model. In some aspects, reducing the size of the video frame can include determining gradient information for the video frame. These aspects can further include downscaling the video frame.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Illustrative embodiments of the present invention are described in detail below with reference to the following drawing figures:

FIG. 1 is a block diagram illustrating an example of a system including a video source and a video analytics system, in accordance with some examples.

FIG. 2 is an example of a video analytics system processing video frames, in accordance with some examples.

FIG. 3 is a block diagram illustrating an example of a blob detection engine, in accordance with some examples.

FIG. 4 is a block diagram illustrating an example of an object tracking engine, in accordance with some examples.

FIG. 5 illustrates an example of a background subtraction engine, in accordance with some examples.

FIG. 6 illustrates an example of a background modeling engine that includes multiple engines for determined background models at different time scales, in accordance with some examples.

FIG. 7 illustrates an example of a process for updating a medium-term background model, in accordance with some examples.

FIG. 8 illustrates an example of a process for updating a long-term background model, in accordance with some examples.

FIG. 9 illustrates an example of a blob detection engine that includes a frame reduction engine, in accordance with some examples.

FIG. 10 illustrates an example of a frame reduction engine, in accordance with some examples.

FIG. 11A-FIG. 11D illustrate an example of an image 1102 and representations of the gradient values for the image, in accordance with some examples.

FIG. 12 illustrates a simple example of a downscaling technique, in accordance with some examples.

FIG. 13A-FIG. 13C illustrate the effect of downscaling and image, and the effect of gradients in a downscaled image that would result from using data reduction techniques, in accordance with some examples.

FIG. 14 is a flowchart illustrating an example of a process for a cascaded-time-scale modeling technique, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a video sequence from a video source and can process the video sequence to provide a variety of tasks. One example of a video source can include an Internet protocol camera (IP camera), or other video capture device. An IP camera is a type of digital video camera that can be used for surveillance, home security, or other suitable applications. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable event the video analytics is programmed to or learns to detect. A detector can trigger the detection of event of interest and sends an alert or alarm to a central control room to alert a user of the event of interest.

To perform the tasks described above, as well as other tasks, a video analytics system can perform operations for detecting objects moving in a scene being viewed by a stationary camera. These operations can include background subtraction, or the separation of background pixels from foreground pixels in a particular video frame. The foreground pixels may subsequently be grouped into blobs. The video analytics system can generate blob trackers for the blobs, which can maintain historical information about blobs as the objects associated with the blobs move around in the scene.

For most background subtraction methods, a video analytics system typically generates a model for the background of a scene. The model can provide, for each pixel location in a video frame, one or more values for a pixel identified as a background pixel. The video analytics system can use the model to generate background and/or foreground masks, and use the background and/or foreground masks to determine foreground pixels and background pixels in a particular video frame.

Some methods for determining a background model use a Gaussian Mixture Model (GMM). In statistics, a mixture model is a probabilistic model for representing the presence of subpopulations within an overall population, without requiring that an observed data set should identify the sub-population to which an individual observation belongs. Gaussian Mixture Models are often used for data clustering. As applied to video analytics, a Gaussian Mixture Model can determine a probability that a pixel at a particular location is associated with the background or the foreground, based on the pixel's values and the pixel values at the same location in prior frames.

While generally good at determining a background model, the Gaussian Mixture Model can have some limitations. For example, the data usage of the Gaussian Mixture Model can be very large, possibly requiring dozens of bytes per pixel (depending on the parameters of the model). For each input video frame, all of the data for each pixel typically needs to be read, modified after processing, and written back to a storage medium. Thus methods that use the Gaussian Mixture Model can potentially require a large amount of data storage, data transmission bandwidth, and/or processing capability.

As another example, the rate at which a video analytics system determines, or “learns” the background of a scene can be tuned, so that the system can learn the background quickly or more slowly. Slow learning, for example, may lead to more accurate background modeling, because moving objects that are temporarily stationary are less likely to be absorbed into the background. A slower learning, rate, however, may require higher precision calculations to control for round-off effects. These higher precision calculations may also increase storage and bandwidth requirements when using the Gaussian Mixture Model.

Methods that use the Gaussian Mixture Model also typically do not take advantage of the spatial correlation between neighboring pixels. In many cases, nearby pixels may have similar or related color values, direction of motion, and/or tendency to change. For example, a group of pixels may represent a stationary object in the background, and as the lighting changes during the day, the group of pixels may change in color in a similar fashion. The Gaussian Mixture Model analyzes the statistical behavior, over time, of each pixel location independently of other pixel locations, and thus in most cases does not make use of the spatial correlation between neighboring pixels.

The Gaussian Mixture Model can build a detailed and robust model of the recent behavior of a region of pixels, modelling, for example, the statistics of a current foreground object in the region while maintaining a previous background state for the region. In a model using the Gaussian Mixture Model, however, it can be difficult to determine which elements of the model apply to the background and which apply to the foreground, and to correlate the foreground and background modeling information among a set of neighboring pixels. As noted above, the Gaussian Mixture Model maintains an independent model for each pixel location, and generally does not make use of the spatial relationships between neighboring pixels. A model that uses the Gaussian Mixture Model can be used to identify background or foreground pixels for a input video frame, though spatial filtering is frequently applied to make the identification more reliable and coherent. A background modeling technique that makes use of the spatial correlation between neighboring pixels may make the identification of background and foreground pixels simpler and/or more robust.

In various implementations, systems and methods are provided for a cascaded-time-scale background modeling technique. The cascaded-time-scale background modeling technique can potentially reduce the data and processing requirements used in determining a background model. In various implementations, the cascaded-time-scale background modeling technique can also use the spatial correlation between neighboring pixels to improve the background model.

In various implementations, the cascaded-time-scale background modeling technique includes maintaining a first background model, referred to herein as the short-term background model. The short-term background model updates frequently, such as, for example, for every input video frame or other suitable number of video frames. The short-term background model thus generally includes the most recent information for the scene, and can vary as objects move in the scene. The short-term background model can be determined using computationally simple methods, such as a Gaussian Mixture Model.

In various implementations, the cascaded-time-scale background modeling technique also includes maintaining a second background model, referred to herein as the medium-term background model. The medium-term background model updates less frequently than the short-term background model. For example, the medium-term background model may update only a few times a second. The medium-term background model is updated using the short-term background model. For example, in some implementations, the medium-term background is updated for pixel locations in the short-term background model that have been determined to be relatively stable, or undergoing little change. For example, the video content analysis system can compare the current short-term background model against the current input video frame to identify areas of the video frame where there is motion versus areas where there is little motion. In some implementations, the video content analysis system may group neighboring pixel locations that are similarly showing motion or lack of motion. In these and other implementations, the medium-term background model can be updated in pixel locations that show little motion, using values from the short-term background model.

In various implementations, the cascaded-time-scale background modeling technique also includes maintaining a third background model, referred to herein as the long-term background model. The long-term background model updates less frequently than the medium-term background model, such as for example once every eight seconds, ten seconds, or other suitable period of time that is less often than the update period of the medium-term background model. In various implementations, the long-term background model is updated using a set of previous medium-term background models. The video content analysis system can identify pixel locations where, in the set of medium term background models, the pixels show little change or a large amount of change. The video content analysis system can update the long-term background model in the areas that show little change, while leaving alone areas that show a large amount of change. In some implementations, the video content analysis system can group pixel locations that show a similar amount of change. In these and other implementations, the long-term background model can be updated in pixel locations that show little change, using values from the set of medium-term background models.

In various implementations, a video content analysis system can include systems and methods for reducing the size of an input video frame, which can reduce the computational complexity for operations such as determining background models. In various implementations, a data reduction technique can include first determining gradient information for an input video frame. The gradient information provides rates of change of color across the input frame. The data reduction technique can further include downscaling the input video frame, where the downscaling process uses both the color values at each pixel location as well as the gradient values. The downscaled input video frame can then be used by the video content analysis system, including in determining background models.

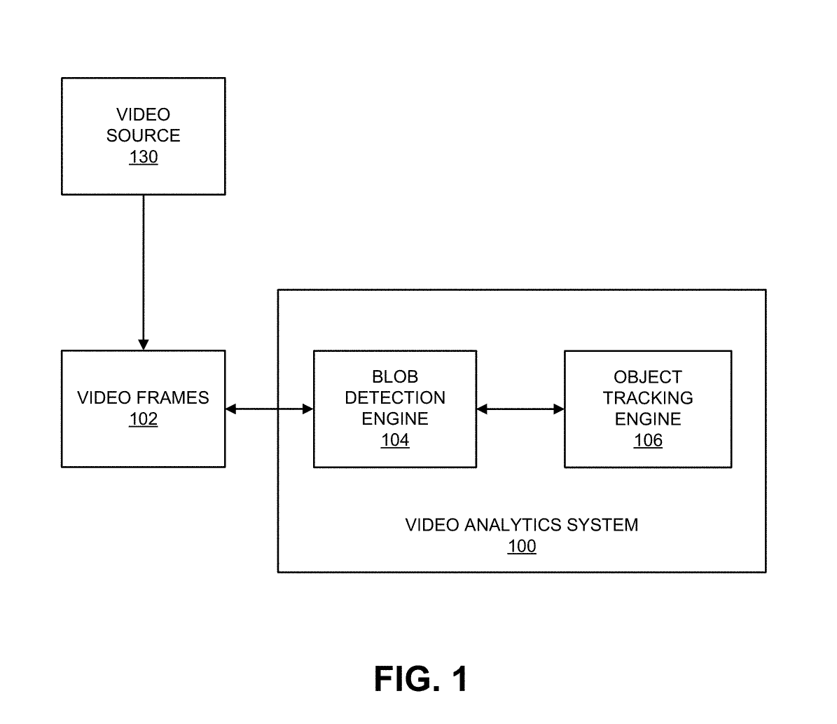

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection engine 104 and an object tracking engine 106. Object detection and tracking allows the video analytics system 100 to provide various end-to-end features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection engine 104 can detect one or more blobs in video frames (e.g., video frames 102) of a video sequence, and the object tracking engine 106 can track the one or more blobs across the frames of the video sequence. As used herein, a blob refers to pixels of at least a portion of an object in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof. In some examples, a bounding box can be associated with a blob. In the tracking layer, in case there is no need to know how the blob is formulated within a bounding box, the term blob and bounding box may be used interchangeably.

As described in more detail below, blobs can be tracked using blob trackers. A blob tracker can be associated with a tracker bounding box and can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, and a history of the velocity, and a history of location, of continuous frames, for the blob tracker, as described in more detail below.

As described in further detail below, a motion model for a blob tracker can determine and maintain two locations of the blob tracker for each frame (e.g., a first location that includes a predicted location in the current frame and a second location that includes a location in the current frame of a blob with which the tracker is associated in the current frame). As also described in more detail below, the velocity of a blob tracker can include the displacement of a blob tracker between consecutive frames.

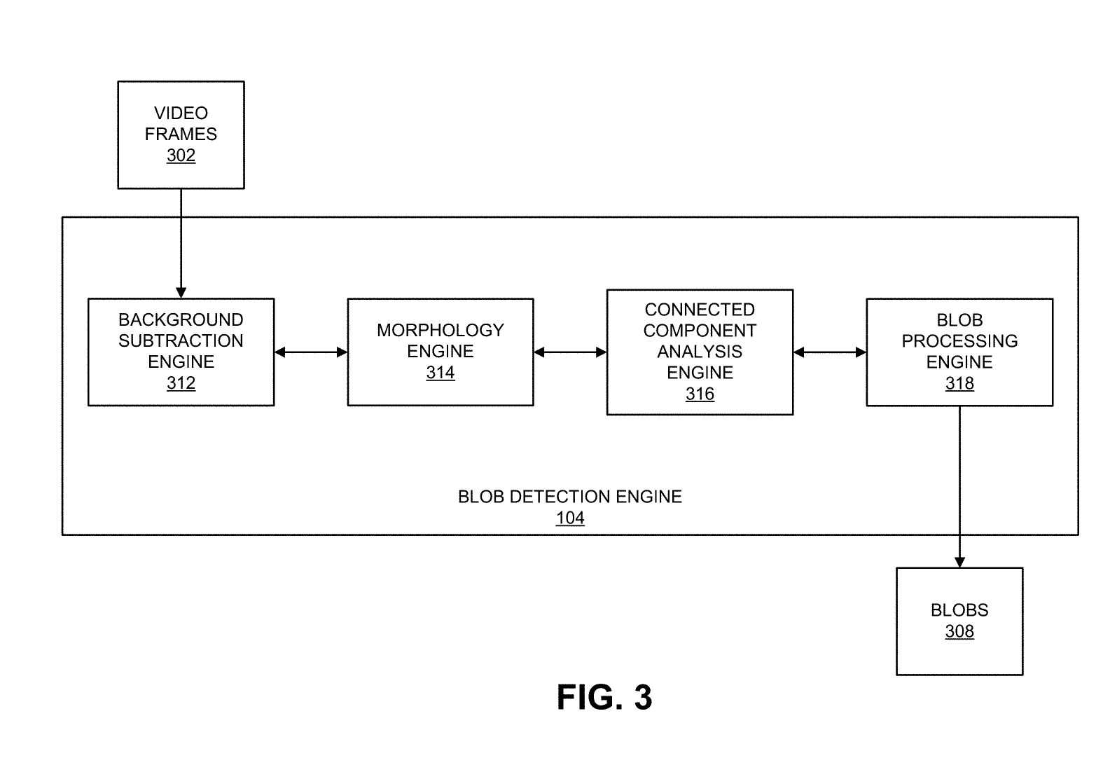

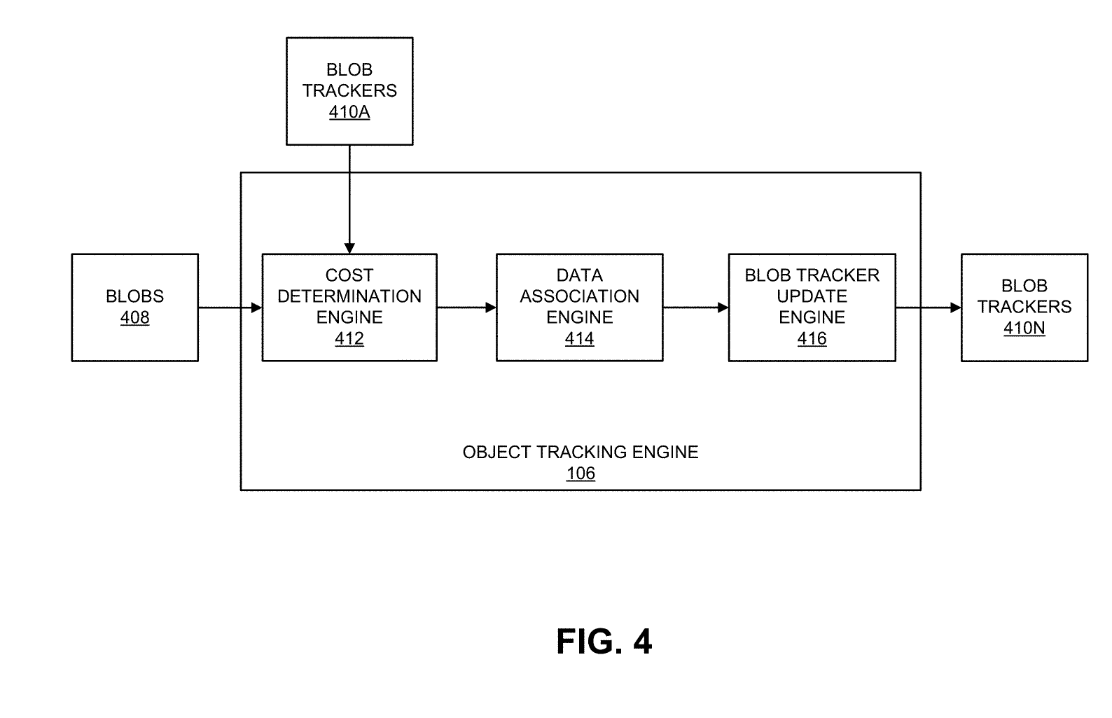

Using the blob detection engine 104 and the object tracking engine 106, the video analytics system 100 can perform blob generation and detection for each frame or picture of a video sequence. For example, the blob detection engine 104 can perform background subtraction for a frame, and can then detect foreground pixels in the frame. Foreground blobs are generated from the foreground pixels using morphology operations and spatial analysis. Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection engine 104 and the object tracking engine 106 are described with respect to FIG. 3-FIG. 4.

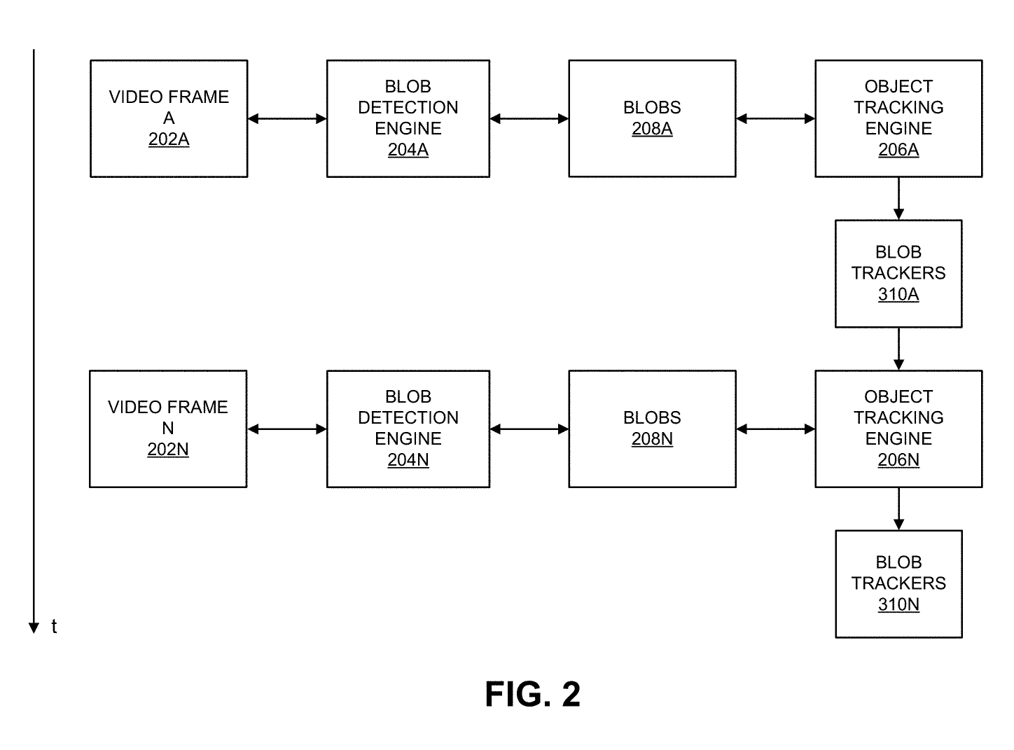

FIG. 2 is an example of the video analytics system (e.g., video analytics system 100) processing video frames across time. As shown in FIG. 2, a video frame A 202A is received by a blob detection engine 204A. The blob detection engine 204A generates foreground blobs 208A for the current frame A 202A. After blob detection is performed, the foreground blobs 208A can be used for temporal tracking by the object tracking engine 206A. Costs (e.g., a cost including a distance, a weighted distance, or other cost) between blob trackers and blobs can be calculated by the object tracking engine 206A. The object tracking engine 206A can perform data association to associate or match the blob trackers (e.g., blob trackers generated or updated based on a previous frame or newly generated blob trackers) and blobs 208A using the calculated costs (e.g., using a cost matrix or other suitable association technique). The blob trackers can be updated, including in terms of positions of the trackers, according to the data association to generate updated blob trackers 310A. For example, a blob tracker's state and location for the video frame A 202A can be calculated and updated. The blob tracker's location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection engine 204N generates foreground blobs 208N for the frame N 202N. The object tracking engine 206N can then perform temporal tracking of the blobs 208N. For example, the object tracking engine 206N obtains the blob trackers 310A that were updated based on the prior video frame A 202A. The object tracking engine 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection engine 104. Blob detection is used to segment moving objects from the global background in a scene. The blob detection engine 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purposes. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (GMM). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

$$P ( {X}_{t} ) = {\sum }_{i = 1}^{K} {ω}_{i , t} N ( {X}_{t} \vert {μ}_{i , t} , {Σ}_{i , t} ) \qquad Equation ( 1 )$$

An equation of the GMM model is shown in equation (1), wherein there are K Gaussian models. Each Gaussian model has a distribution with a mean of μ and variance of 1, and has a weight ω. Here, i is the index to the Gaussian model and t is the time instance. As shown by the equation, the parameters of the GMM change over time after one frame (at time t) is processed.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask generated from background subtraction, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel, which is currently being processed. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with a 3×3 window size is called first, and three function calls of dilation of the 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. One example of the connected component analysis performed by the connected component analysis engine 316 is implemented as follows:

for each pixel of the foreground mask {
if it is a foreground pixel and has not been processed, the following steps apply:
   Apply FloodFill function to connect this pixel to other foreground and generate a connected component
   Insert the connected component in a list of connected components.
   Mark the pixels in the connected component as being processed. }

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or −1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection engine 104. In some examples, the blob processing engine 318 can perform content-based filtering of certain blobs. For instance, a machine learning method can determine that a current blob contains noise (e.g., foliage in a scene). Using the machine learning information, the blob processing engine 318 can determine the current blob is a noisy blob and can remove it from the resulting blobs that are provided to the object tracking engine 106. In some examples, the blob processing engine 318 can merge close blobs into one big blob to remove the risk of having too many small blobs that could belong to one object. In some examples, the blob processing engine 318 can filter out one or more small blobs that are below a certain size threshold (e.g., an area of a bounding box surrounding a blob is below an area threshold). In some embodiments, the blob detection engine 104 does not include the blob processing engine 318, or does not use the blob processing engine 318 in some instances. For example, the blobs generated by the connected component analysis engine 316, without further processing, can be input to the object tracking engine 106 to perform blob and/or object tracking.

FIG. 4 is a block diagram illustrating an example of an object tracking engine 106. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking engine 106 can obtain the blobs 408 of a current video frame from the blob detection engine 104. The cost determination engine 412 can also obtain the blob trackers 410A updated from the previous video frame (e.g., video frame A 202A). A cost function can then be used to calculate costs between the object trackers 410A and the blobs 408. Any suitable cost function can be used to calculate the costs. In some examples, the cost determination engine 412 can measure the cost between a blob tracker and a blob by calculating the Euclidean distance between the centroid of the tracker (e.g., the bounding box for the tracker) and the centroid of the bounding box of the foreground blob. In one illustrative example using a 2-D video sequence, this type of cost function is calculated as below:

Cost_{tb}=\sqrt{(tₓ−bₓ)²+(t_{y}−b_{y})²}

The terms (tₓ, t_{y}) and (bₓ, b_{y}) are the center locations of the blob tracker and blob bounding boxes, respectively. As noted herein, in some examples, the bounding box of the blob tracker can be the bounding box of a blob associated with the blob tracker in a previous frame. In some examples, other cost function approaches can be performed that use a minimum distance in an x-direction or y-direction to calculate the cost. Such techniques can be good for certain controlled scenarios, such as well-aligned lane conveying. In some examples, a cost function can be based on a distance of a blob tracker and a blob, where instead of using the center position of the bounding boxes of blob and tracker to calculate distance, the boundaries of the bounding boxes are considered so that a negative distance is introduced when two bounding boxes are overlapped geometrically. In addition, the value of such a distance is further adjusted according to the size ratio of the two associated bounding boxes. For example, a cost can be weighted based on a ratio between the area of the blob tracker bounding box and the area of the blob bounding box (e.g., by multiplying the determined distance by the ratio).

In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, may be based on the determined costs. The data association engine 414 matches or assigns a tracker with a corresponding blob and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

In addition to the Hungarian method, other robust methods can be used to perform data association between blobs and blob trackers. For example, the association problem can be solved with additional constraints to make the solution more robust to noise while matching as many trackers and blobs as possible.

Regardless of the association technique that is used, the data association engine 414 can rely on the distance between the blobs and trackers. The location of the foreground blobs are identified with the blob detection engine 104. However, a blob tracker location in a current frame may need to be predicated from a previous frame (e.g., using a location of a blob associated with the blob tracker in the previous frame). The calculated distance between the identified blobs and estimated trackers is used for data association. After the data association for the current frame, the tracker location in the current frame can be identified with its associated blob's (or blobs') location in the current frame. The tracker's location can be further used to update the tracker's motion model and predict its location in the next frame.

Once the association between the blob trackers 410A and blobs 408 has been completed, the blob tracker update engine 416 can use the information of the associated blobs, as well as the trackers' temporal statuses, to update the states of the trackers 410A for the current frame. Upon updating the trackers 410A, the blob tracker update engine 416 can perform object tracking using the updated trackers 410N, and can also provide the update trackers 410N for use for a next frame.

The state of a blob tracker can include the tracker's identified location (or actual location) in a current frame and its predicted location in the next frame. The state can also, or alternatively, include a tracker's temporal status. The temporal status can include whether the tracker is a new tracker that was not present before the current frame, whether the tracker has been alive for certain frames, or other suitable temporal status. Other states can include, additionally or alternatively, whether the tracker is considered as lost when it does not associate with any foreground blob in the current frame, whether the tracker is considered as a dead tracker if it fails to associate with any blobs for a certain number of consecutive frames (e.g., 2 or more), or other suitable tracker states.

Other than the location of a tracker, there may be other status information needed for updating the tracker, which may require a state machine for object tracking. Given the information of the associated blob(s) and the tracker's own status history table, the status also needs to be updated. The state machine collects all the necessary information and updates the status accordingly. Various statuses can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other objects of interest) intersect, the two trackers associated with the two objects will be merged together for certain frames, and the merge or occlusion status needs to be recorded for high level video analytics.

One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified at its predicted location from the previous frame, meaning that the motion model for the blob tracker is not corrected and the prediction propagates with the blob tracker's last model (from the previous frame).

Regardless of the tracking method being used, a new tracker starts to be associated with a blob in one frame and, moving forward, the new tracker may be connected with possibly moving blobs across multiple frames. When a tracker has been continuously associated with blobs and a duration has passed, the tracker may be promoted to be a normal tracker and output as an identified tracker-blob pair. A tracker-blob pair is output at the system level as an event (e.g., presented as a tracked object on a display, output as an alert, or other suitable event) when the tracker is promoted to be a normal tracker. A tracker that is not promoted as a normal tracker can be removed (or killed), after which the track can be considered as dead.

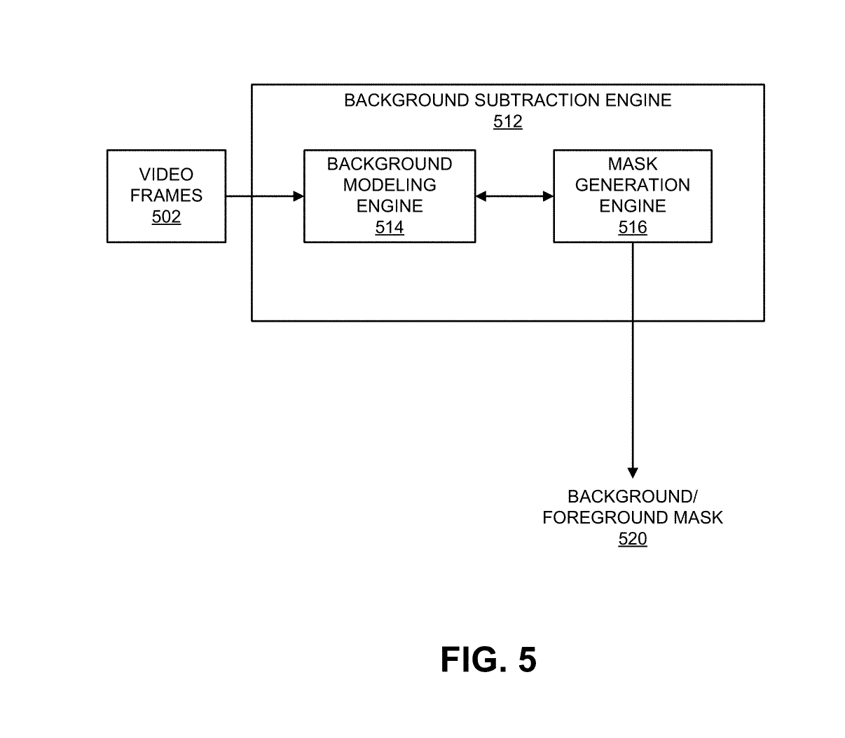

As discussed above, object tracking includes determining blobs for an input video frame, for example using a blob detection engine. As also discussed above, in various implementations, a blob detection engine can include a background subtraction engine for determining the background and foreground pixels in the input video frame. FIG. 5 illustrates an example of a background subtraction engine 512. In various implementations, the background subtraction engine 512 includes a background modeling engine 514 and a mask generation engine 516. The background subtraction engine 512 can receive a sequence of video frames 502, which are being processed to identify and track blobs. The background subtraction engine 512 can output a background/foreground mask 520 determined for a particular input video frame 502.

The background modeling engine 514 determines a background model for a scene. For example, when the background subtraction engine 512 receives an input video frame 502, the background modeling engine 514 can, for each pixel location in the input video frame 502, make a statistical determination as to whether the pixel location in the input video frame 502 represents a background pixel or a foreground pixel. As additional video frames 502 are received, the background modeling engine 514 can adjust and modify the statistical determination for each pixel location. Thus, over time, the background model determined by the background modeling engine 514 can “learn” the pixel values that represent the background, for each pixel location in a captured scene. Additionally, the background model can adjust as the background changes due to, for example, changes in lighting, moving shadows, and objects becoming features of the background or being removed as features from the background. For each input video frame 502, the background modeling engine 514 can output an updated background model.

In various implementations, the background modeling engine 514 can use a cascaded-time-scale modeling technique, as described further below. In these implementations, the background modeling engine 514 may output one or more background models, including a short-term background model, a medium-term background model, and/or a long-term background model. One or more of these background models can be provided to the mask generation engine 516. The background models output by the background modeling engine 514 can also be output for use by other parts of the video analytics system.

The mask generation engine 516 can use a background model to generate a background/foreground mask 520. The background/foreground mask 520 can indicate, for each pixel location in a particular input video frame, whether the pixel location corresponds to the background or the foreground of the particular video frame. In some cases, there may be no foreground pixels, such as for example when no objects are moving in the scene. In some cases, the background pixels may include objects that were formerly foreground objects, but that have stopped moving and thus have appeared to be part of the background. The background/foreground mask 520 can be used, for example, for determining the blobs in the particular video frame.

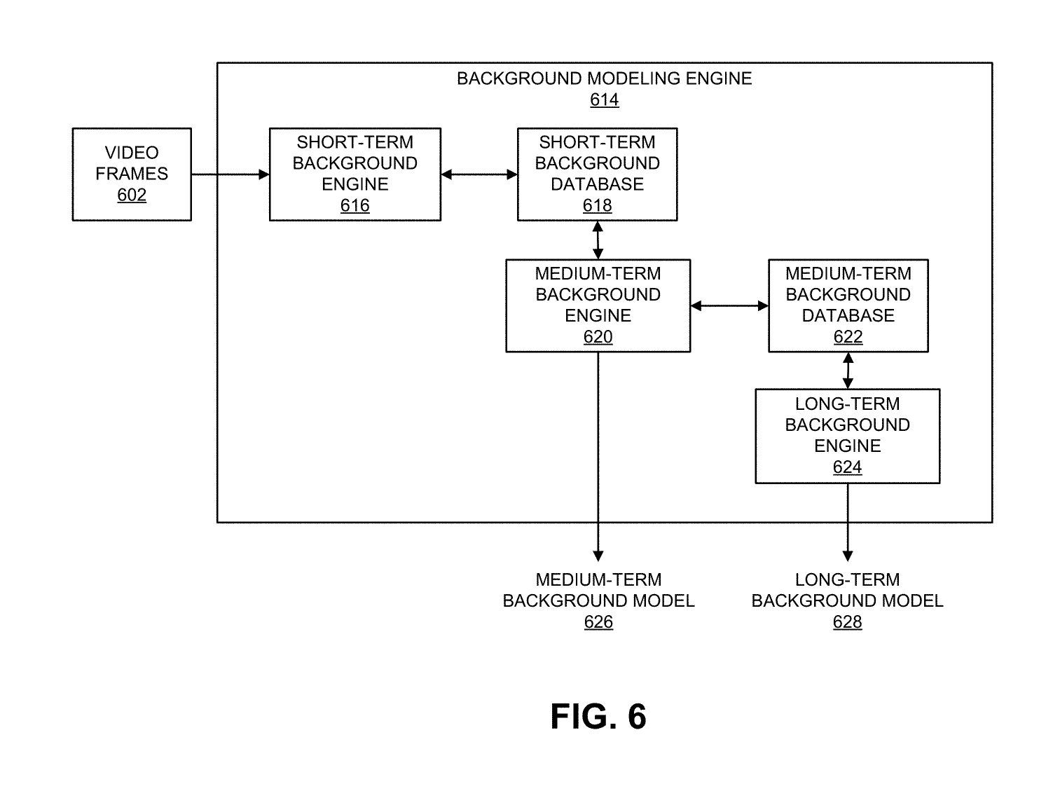

As noted above, in some implementations, the background modeling engine 514 can use a cascaded-time-scale modeling technique to determine background models at different time scales. FIG. 6 illustrates an example of a background modeling engine 614 that includes multiple engines for determining background models at different time scales. In various implementations, the background modeling engine 614 can determine a short-term background model using a short-term background engine 616, a medium-term background model 626 using a medium-term background engine 620, and a long-term background model 628 using a long-term background engine 624.

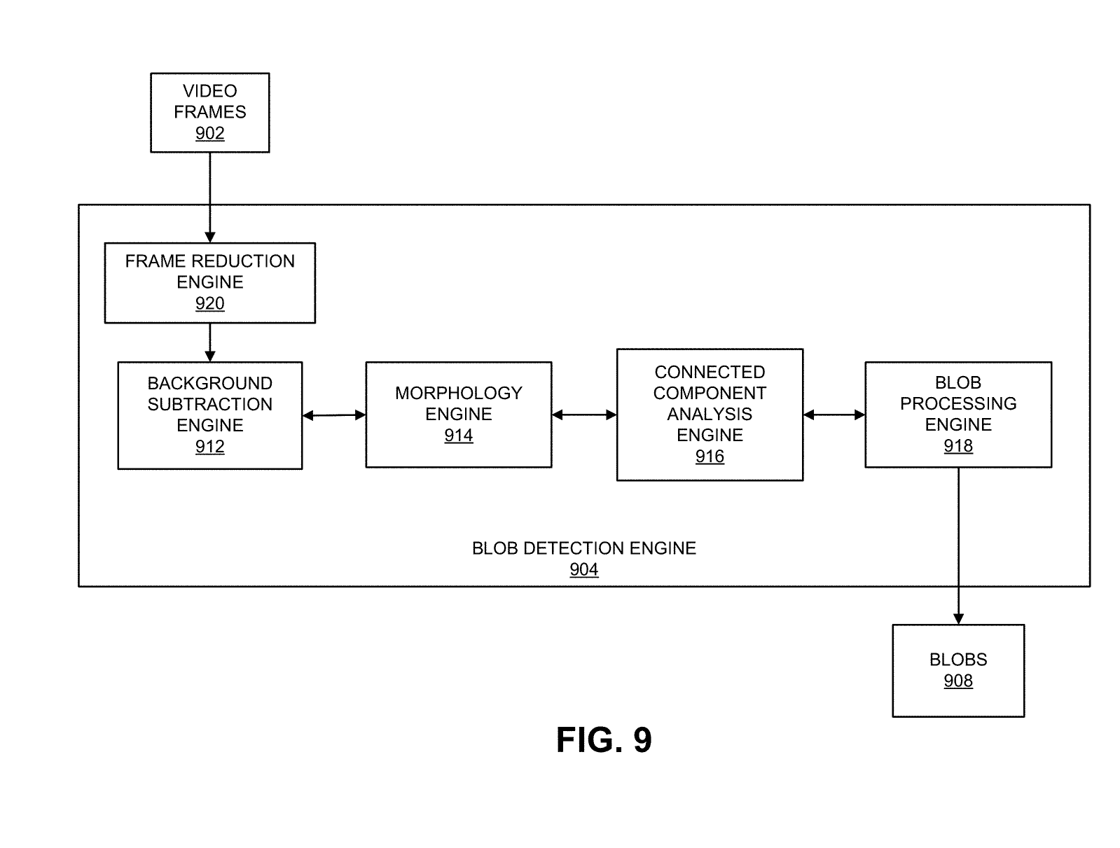

As discussed above, the background modeling engine 614 can receive the video frames 602 received by a background subtraction engine. In some implementations, the video frames 602 undergo a data reduction process before the video frames 602 are received by the background subtraction engine. The data reduction process can reduce the size of an input video frame 602 (e.g., the number of bits or bytes used to represent the input video frame 602), possibly reducing the amount of data that is computed over by an engine such as the background modeling engine 614. An example of a data reduction process is described with respect to FIGS. 9, 10, 11A-11D, 12, and 13A-13C.

In the example of FIG. 6, the background modeling engine 614 provides the input video frames 602 to a short-term background engine 616. The short-term background engine 616 can determine a first background model, which may be referred to as a short-term background model. The short-term background engine 616 determines a background model from the input video frames. The short-term background engine 616 can update the short-term background for every input video frame 602, or for every other frame, or for every fourth frame, or for some other interval of frames.

To update the short-term background model, the short-term background engine 616 may examine every pixel location in the current input video frame, and determine a statistical likelihood that the pixel in a pixel location is a background pixel. The short-term background engine 616 may make this determination using, for example, the Gaussian Mixture Model. In some implementations, short-term background engine 616 may use a simplified Gaussian Mixture Model, for example a Gaussian Mixture Model with a single mode per pixel. In various implementations, the short-term background engine 616 may be optimized to maintain the most up-to-date background information that is possible, rather than the most accurate background information. In these implementations, medium-term background engine 620 and/or the long-term background engine 624 may be optimized for accuracy, rather than computational speed.

In various implementations, the short-term background engine 616 maintains a running average, or some other cumulative value, of the pixel values at a particular pixel location, as well as a standard deviation estimate for the values at the pixel location. The pixel values can include, for example, three color values (e.g., red, green, and blue when using an RGB color space, or luma, chroma-red, chroma-blue when using a YUV color space). In some implementations, the pixel values can also include a gradient value for each color value, such as for example when an input video frame 602 has been reduced in size using the data reduction techniques discussed below.

In these and other implementations, the short-term background model stores, for each pixel location, mean (e.g., the running average noted above), median, or other cumulative value for each pixel component (e.g., three color components, or three color components and three gradient components). In various implementations, the cumulative values of the pixel components may be stored using 16-bit unsigned numbers, which can include eight fractional bits relative to the input pixel values. The short-term background model can also store one or more standard deviation values. The standard deviations values can be similar to the variance values used in the Gaussian Mixture Model, in that the standard deviation values model the variance over time of the pixel values being modeled, where the time frame is the same as the time frame used to determine the cumulative values of the pixel values. In some implementations, the short-term background model can include one or more standard deviation values for the three color values, stored as the square root of the variance. In some implementations, the short-term background model can also include one or more standard deviation values for the gradient values, also stored as the square root of the variance. In various implementations, the standard deviation values are each stored using an unsigned 16-bit number.

In various implementations, short-term background models determined by the short-term background engine 616 can be added to a short-term background database 618. The short-term background database 618 can be a data structure, database, or other data format, stored in volatile or non-volatile memory of the background modeling engine 614. In some implementations, the short-term background database 618 can be stored at, and retrieved from, a remote storage location. The short-term background database 618 can store previous versions of the short-term background model, such as the most recent two, three, five, or some other number of versions. Alternatively, in some implementations, the short-term background database 618 can include only the most current short-term background model. In these implementations, the running average (or other cumulative value) maintained by the short-term background model may provide enough information to determine a medium-term background model.

Generally, the short-term background engine 616 updates the short-term background model quickly (e.g., every frame, every other frame, or other interval), which may result in the short-term background model “learning” the background too quickly. Slowly moving objects, objects that are temporarily stationary, and objects that are uniform in color may be absorbed into the short-term background model, or may be detected only at their leading or trailing edges, possibly resulting in inaccurate tracking of these objects. Thus, in various implementations, the background modeling engine 614 includes a medium-term background engine 620, which maintains and updates a second background model, referred to as the medium-term background model 626.

The medium-term background engine 620 updates the medium-term background model 626 at a slower rate than the rate at which the short-term background engine 616 updates the short-term background model. For example, the medium-term background engine 620 may update the medium-term background model a few times a second, once per second, or some other interval of time. In some implementations, the medium-term background engine 620 includes a timer that counts fractions of a second, and when a pre-determined, possibly configurable time limit is reached, the medium-term background engine 620 will update the medium-term background model 626. In some implementations, the medium-term background engine 620 counts input video frames 602, and when a pre-determined, possibly configurable number of input video frames 602 is reached, the medium-term background engine 620 will update the medium-term background model 626.

The medium-term background engine 620 generally updates the medium-term background model 626 using similar techniques as used by the short-term background engine 616 to update the short-term background model, but instead of using input video frames 602 to update the medium-term background model 626, the medium-term background engine 620 engine uses short-term background models from the short-term background database 618. For example, after ten (or some other number) input video frames 602, the medium-term background engine 620 may examine the current short-term background model. In this example, examining the current short-term background model can include determining, for each pixel location in the short-term background model, a statistical likelihood that the pixel at the pixel location represents a background pixel. The medium-term background engine 620 can make this statistical determining use, for example, the Gaussian Mixture Model. Because the medium-term background model 626 updates less frequently than the short-term background model, the medium-term background engine 620 can execute more computationally complex operations, and thus need not restrict the Gaussian Mixture Model to one mode per pixel.

In some implementations, the medium-term background engine 620 maintains a running average (or some other cumulative value) for two or more previous short-term background models. In these implementations, the medium-term background engine 620 may accumulate pixel values from one or more short-term background models stored in the short-term background database 618, computing, for example, a set of mean color and variance values for each pixel location. In some implementations, the medium-term background engine 620 only considers the current short-term background model. In these implementations, the current short-term background model provides cumulative values across the previous n number of input video frames 602, where the n number of input video frames are most or all of the video frames 602 received since the last time the medium-term background engine 620 updated the medium-term background model 626. In these implementations, the medium-term background model 626 statistically incorporates each video frame 602 that was used to update the short-term background model.

In some implementations, the medium-term background engine 620 may selectively update areas of the medium-term background model 626. In these implementations, the medium-term background engine 620 may be configured to use areas of the short-term background model that appear to be “stable,” meaning undergoing no change or changing only little. Identifying stable areas can enable the medium-term background engine 620 to ignore transient foreground objects while incorporating persistent motion (e.g. moving tree branches). The medium-term background engine 620 may also be able to appropriately update the medium-term background model 626 when there is a long-term change to the background (e.g., a parked car drives away).

In various implementations, to identify stable areas in the short-term background, the medium-term background engine 620 may conduct a simplistic motion detection by comparing the current medium-term background model against the current input video frame 602, and looking for differences. In these implementations, the medium-term background engine 620 can, for each pixel location in the medium-term background model and the input video frame 602, determine whether the difference between the pixel values in the medium-term background model and the input video frame 602 at the pixel location are less than a difference threshold. When the difference is less than the difference threshold at a pixel location, the medium-term background engine 620 can identify the pixel location as stable. The medium-term background engine 620 may then use the pixel locations identified as stable to update the medium-term background 626. When the difference at a pixel location is equal to or greater than the difference threshold, the medium-term background engine 620 may leave unchanged the pixel location in the medium-term background 626.

Having identified stable pixel locations in the short-term background model, in some implementations, the medium-term background engine 620 may group together neighboring pixel locations that are similarly identified as stable or not stable. For example, when a pixel location identified as stable is partially or entirely surrounded by pixel locations that are also identified as stable, the pixel location and its surrounding pixel locations may be treated as a group. Similarly, pixel locations identified as not stable can be grouped with surrounding pixel locations that are also identified as not stable. Conversely, when a pixel location is identified as stable and is mostly surrounded by pixel locations identified as not stable, the pixel location may be noise, an encoding anomaly, or some other aberration that need not be considered. Such a pixel location may be re-identified as a not stable pixel, and be grouped with its surrounding not stable pixels. Similarly, a pixel location initially identified as not stable, but surrounding by pixel locations identified as stable may be re-identified as a stable pixel.

By grouping together stable and not stable pixels, in these implementations the medium-term background engine 620 may incorporate spatial correlations between neighboring pixels. For example, neighboring pixels may represent the same object, such as a car, or a portion of the background. In these and other examples, an area in the medium-term background model encompassing a group of pixel locations may be updated using a similar process (e.g. by computing values over some previous number of short-term background models, or by taking values from the current short-term background model). Treating pixel locations as a group may simplify the updating of the medium-term background model.

In various implementations, the medium-term background model 626 stores, for each pixel location, pixel values for each component of a pixel (e.g., three color values). The pixel values may be stored, for example, using unsigned 16-bit numbers that include eight additional fractional bits relative to the input pixels. In some implementations, the medium-term background model 626 also stores one or more standard deviation values, which model the variance over time of the color component values. For example, the medium-term background model 626 can include, for each pixel location, one or more standard deviation values for the three color values, and/or one or more standard deviation values for three gradient values.

The background modeling engine 614 may output the medium-term background model 626 for use by other parts of the video analysis system. For example, a background subtraction engine may use the medium-term background model 626 for mask generation and to determine background and foreground pixels for an input video frame. Because the medium-term background model 626 is updated less frequently than the short-term background model, the medium-term background model can “learn” the background of the scene more slowly, and thus possibly avoid absorbing slowly moving objects and temporarily stationary objects. The medium-term background model 626 may thus better reflect the stable portions of the scene than does the short-term background model, and thus be more suitable for background subtraction.

In various implementations, the medium-term background engine 620 may also add the current medium-term background model 626 to a medium-term background database 622. The medium-term background database 622 can be a data structure, database, or other data format stored on volatile or non-volatile memory. The medium-term background database 622 can be local to the background modeling engine 614, or can be located at a remote storage location. The medium-term background database 622 can include the most recent one, two, three, five, or some other number of medium-term background models. Alternatively, in some implementations, the medium-term background database 622 can include only the most recent medium-term background model 626.

In various implementations, the background modeling engine 614 can also include a long-term background engine 624. In these implementations, the long-term background engine 624 can maintain and update a third background model, referred to as the long-term background model 628. The long-term background engine 624 updates the long-term background model 628 less frequently than the rate at which the medium-term background model 626 is updated. For example, the long-term background engine 624 may update the long-term background model 628 once every four, eight, ten, or some other number of seconds. In some implementations, the long-term background engine 624 can include a timer that counts seconds or fractions of a second, and when a pre-determined, possibly configurable time limit is reached, the long-term background engine 624 will update the long-term background model 628. Alternatively, the long-term background engine 624 can include a counter that counts input video frames 602, and when a pre-determined, possibly configurable number of video frames 602 is reached, the long-term background engine 624 will update the long-term background model 628.

The long-term background engine 624 uses one or more medium-term background models from the medium-term background database 622 to update the long-term background model 628. In some implementations, the long-term background engine 624 can update the long-term background model 628 using similar processes as used by the short-term background engine 616 to update the short-term background model, or as used by the medium-term background engine 620 to update the medium-term background model 626. For example, the long-term background engine 624 can maintain a running average (or some other cumulative value) of pixel values at each pixel location in the medium-term background model 626. In this example, the long-term background engine 624 can use the Gaussian Mixture Model to maintain the cumulative pixel values. In some implementations, the long-term background engine 624 can also update primarily areas of the long-term background model 628 that show little change (e.g., little motion) as compared to the current input video frame 602. For example, in these implementations, the long-term background engine 624 can compare the current long-term background model against the current input frame, and identify “stable” areas in the input frame. In this example, the long-term background engine 624 can update primarily the stable areas in the long-term background model 628, using values from one or more medium-term background models.

In various implementations, the long-term background engine 624 can, alternatively or additionally, update the long-term background model 628 by determining, using a set of medium-term background models, the degree of change at each pixel location in the medium-term background models. The set of medium-term background models can include one or more previous medium-term background models, as well as the current medium-term background model, as determined by the medium-term background engine 620 and stored in the medium-term background database 622. In some implementations, the set of medium-term background models includes consecutive medium-term background models. In some implementations, the set of medium-term background models includes medium-term background models captured each time the long-term background model 628 was updated (e.g., if the long-term background model updates every eight seconds, the set includes medium-term background models captured at eight-second intervals). Using the set of medium-term background models, the long-term background engine 624 can identify pixel locations that are relatively stable or consistent in each of the medium-term background models in the set. Having identified such pixel locations, the long-term background engine 624 can update the long-term background model 628 using values from the set of medium-term background models.

To identify pixel locations that are relatively stable or consistent, in some implementations, the long-term background engine 624 can, for each pixel location, examine each of the medium-term background models in the set, and determine a change status for the pixel location. A pixel location may exhibit no change across the set of medium-term background models, a gradual change, a trending change, or inconsistent change. Gradual or trending changes may be seen when, for example, the pixel location may be affected by slow changes in lighting, shadows moving with the angle of the sun, and/or the persistent movement of stationary objects such as trees. Inconsistent changes may be seen when foreground objects have been moving over an area of the scene for some time.

To determine the change status for a pixel location, the long-term background engine 624 can extract pixel values from the same pixel location from each medium-term background model in the set. The long-term background engine 624 can then, for example, use various methods for fitting the pixel values to a trend line. The long-term background engine 624 can then determine a degree of change based on how well the pixel values fit to the trend line. When the majority of pixel values fall close to the trend line (e.g., 80%, or some other percentage, are within a threshold distance to the line), the long-term background engine 624 can determine that the degree of change is less than a change threshold, and assign a “low degree of change” status to the pixel location. When few of the pixel values fall close to the trend line (e.g., fewer than 80%, or some other percentage, are within a threshold distance to the line), the long-term background engine 624 can determine that the degree of change is equal to or greater than the change threshold, and assign a “high degree of change” status to the pixel location.

In some implementations, having determined the degree of change at each pixel location, the long-term background engine 624 may group neighboring pixel locations that have a similar degree of change. For example, a pixel location identified as having a low degree of change that is partially or mostly surrounding by pixel locations also having a low degree of change may be grouped together with the neighboring pixel locations that have a low degree of change. Similarly, a pixel location identified as having a high-degree of change that is partially or mostly surrounded by pixel locations also having a high-degree of change may be grouped with those surrounding pixel locations. Conversely, a pixel location having a low degree of change that is mostly surrounded by pixel locations having a high-degree of change will not be grouped with any other pixel locations. In some implementations, such a pixel location may have its change status reset to “high-degree of change” on the assumption that the pixel location is a statistical outlier. Similarly, a pixel location having a high-degree of change that is mostly surrounding by pixel locations having a low-degree of change will not be grouped, and may have its change status reset to “low-degree of change.”

By grouping pixel locations with similar change statuses, the long-term background engine 624 can incorporate spatial correlations between neighboring pixels. For example, pixel locations with a same change status can represent a stable background area, or can represent an area where objects are moving about. In this and other examples, the long-term background engine 624 can update the long-term background model 628 for groups of pixel locations showing a low degree of change, and not update groups of pixel locations showing a high-degree of change. In this ways, areas in the medium-term background model that may be changing frequently due to objects moving about are not absorbed into the long-term background model. In various implementations, the long-term background engine 624 can update grouped pixel locations in a similar fashion. For example, the long-term background engine 624 can update a group of pixel locations with pixel values each derived in the same fashion from the set of medium-term background models.

In various implementations, the long-term background engine 624 can update a pixel location in the long-term background model 628 by copying the corresponding value from the same location in the current medium-term background model 626. Alternatively, the long-term background engine 624 can compute a new value for a pixel location. For example, the long-term background engine 624 can determine a mean, median, or some other cumulative value using values taken for same pixel location in each of medium-term background models in the set. As another example, when the pixel values at a pixel location follow a trend across the set of medium-term background models, the long-term background engine 624 can compute pixel values that follow the trend.

While pixel locations identified as having a low-degree of change may be stable, the pixel locations may nevertheless reflect a change to the background of the scene. For example, a car may have been parked, or an object may have been dropped and abandoned in the scene. To identify such changes to the background, in various implementations, the long-term background engine 624 may compare the current long-term background model 628 against one or more of the medium-term background models in the medium-term background database 622. When pixel locations in the current long-term background model 628 are similar to, for example, the current medium-term background model 626, the long-term background engine 624 can determine that these pixel locations have undergone a “small change.” The long-term background engine 624 can determine similarity by, for example, determining whether the difference between a pixel location in the long-term background engine 624 and one or more medium-term background models exceed a similarity threshold. When the difference is greater than the similarity threshold, the long-term background engine 624 can mark the pixel location as having a “large change.” Large changes reflect possibly indefinite changes to the background of the scene.

In various implementations, the background modeling engine 614 may output a “change event” when the long-term background model 628 has been updated with a large change. The change event may be used by other parts of the video analysis system. For example, the video analysis system may be configured to track changes to the background of the scene, log the changes, and/or to report such changes to a system administrator. In various implementations, the change event may be accompanied by a timestamp, which indicates the point at which the change was determined. In various implementations, the background modeling engine 614 may also output the current long-term background model 628, also for use by other parts of the video analysis system.

In some implementations, the background modeling engine 614 or some other part of the video analysis system may maintain previous versions of the long-term background model 628. Previous versions of the long-term background model 628 can be used, for example, to track the history of the background of the scene. For example, a car being parked in the scene and left for some amount of time can be reported as a change event. In this example, when the car later leaves the scene, the video analysis system can report this event by determining that the long-term background model 628 has reverted to a previously known state.

Using the processes described above, the long-term background engine 624 can be configured to update the long-term background model 628 when the medium-term background model is stable or consistent, and/or when the medium-term background model 626 is different from the long-term background model 628. In this way, the long-term background model 628 can capture changes to the background that would otherwise be absorbed into the short-term and medium-term background models.

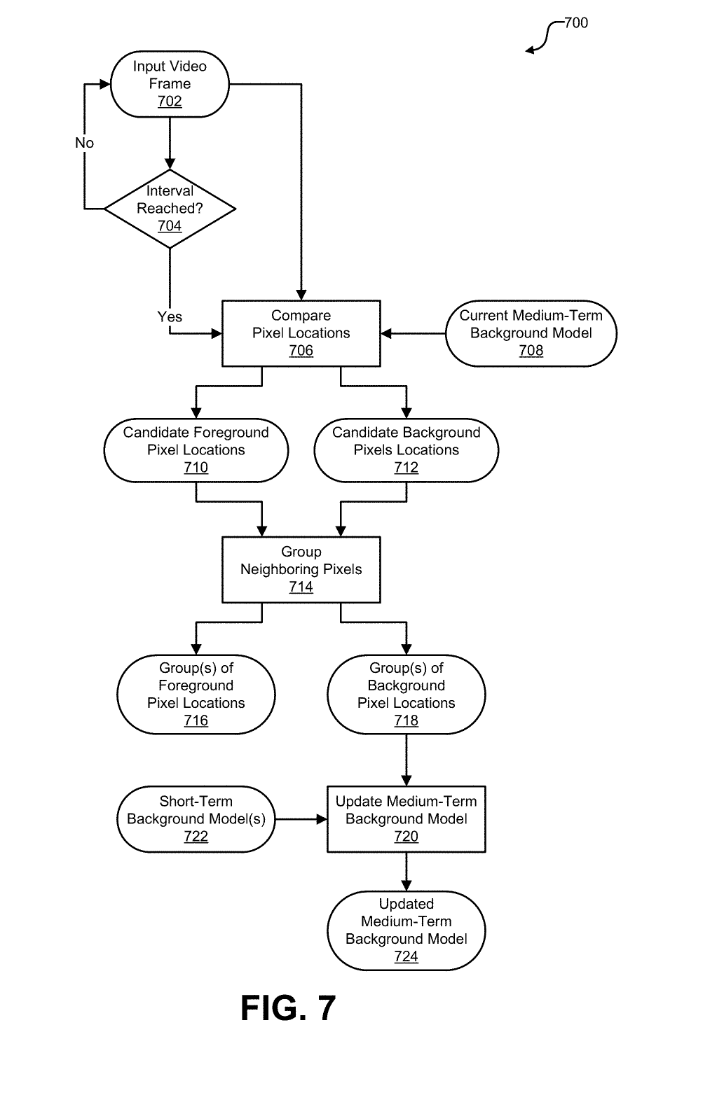

FIG. 7 illustrates an example of a process 700 for updating a medium-term background model. The process 700 can be implemented, for example, by the medium-term background engine 620 of FIG. 6. The example process 700 of FIG. 7 is optional, in that the medium-term background model can be updated using only the current short-term background model, or several previous short-term background models. For example, each time the time interval for updating the medium-term background model is reached, the medium-term background model can copy or accumulate (e.g., include into a running average) the pixel values from the one or more short-term background model.

The example process 700 may be triggered by the receipt of an input video frame 702. The input video frame 702 may be received by, for example, a video analysis system that includes a background modeling engine. For each input video frame 702, the process 700 may check, at step 704, whether an interval has been reached. The interval may be a count of input video frames 702 (e.g., 5, 10, 20, etc. frames) and/or may be a count of fractions of a second (e.g., 10 ms, 30 ms, 60 ms. etc.). When, at step 704, the process 700 determines that the interval has not been reached, the process 700 waits for the next input video frame 702.

When the process 700 determines, at step 704, that the interval has been reached, the process 700 proceeds to step 706. At step 706, the process 700 can compare the current input video frame 702 against the current medium-term background model 708. Specifically, the process 700 can compare each pixel location in the input video frame 702 against a corresponding pixel location in the current medium-term background model 708. This comparison can provide a rough idea of which areas in the input video frame 702 include foreground objects (that is, objects that are moving), and which areas of the input video frame 702 are relatively stable. The comparison of step 706 need not be as detailed as the processes involved in extracting blobs from the input video frame 702, since the comparison only aims for an approximate determination of the stable areas of the input video frame 702.

The comparison of step 706 can determine a difference between pixel values in the input video frame 702 and corresponding pixel values in the current medium-term background model 708. In some implementations, the difference can be computed for each color component (and, in some implementations, each gradient component) at a pixel location. In some implementations, the difference can be computed for an overall pixel value at the pixel location. The comparison step can further compare this difference to a difference threshold. When the difference for each pixel location is equal to or greater than the difference threshold, the pixel location is added to a set of candidate foreground pixel locations 710. When the difference is less than the difference threshold, the pixel location is added to a set of candidate background pixel locations 712. In some cases, the comparison step 706 may output no candidate foreground pixel locations 710, such as for example when there were no moving objects in the input video frame 702. In some cases, the comparison step 706 may output no candidate background pixel locations, 712, such as for example when a large number of moving objects were in the input video frame 702 at the same time.

The comparison step 706 examines each pixel location individually. Thus, in some implementations, the process 700 may next, at step 714, group neighboring pixel locations from each of the candidate foreground pixel locations 710 and the candidate background pixel locations 712 based on spatial similarity between the pixel values at each pixel location. Specifically, the process 700 may look for candidate foreground pixel locations 710 whose color, gradient, direction of motion, or some other quality are the same as in neighboring pixel locations. Similarly, the process 700 may group together candidate background pixel locations 712 with color, gradient, direction of motion, or some other quality that is similar to neighboring pixels. The grouping step 714 may be similar to a morphology operation used to group foreground pixels into blobs.

The grouping step 714 enables a video content analysis system to make use of the spatial correlation between neighboring pixels. Groups of similar, neighboring pixel locations may represent single stationary or moving objects, and thus can be used by the update step 720 in a similar fashion. Additionally, lone pixel locations that are not near similar pixel locations can be ignored or eliminated from consideration, which may simplify the updating operations of step 720. In some implementations, ungrouped pixel locations may be converted to be similar to neighboring pixel locations, so that the ungrouped pixel locations can be added to a group.

The grouping step 714 can output one or more groups of foreground pixel locations 716 and one or more groups of background pixel locations 718. In some cases, the grouping step 714 may output no groups of foreground pixel locations 716. In some cases, the grouping step 714 may output no groups of background pixel locations 718.

In some implementations, the grouping step 714 is optional. In these implementations, the update step 720 can update the medium-term background model using the candidate background pixel locations 712.

The candidate background pixel locations 712 as well as the groups of background pixel locations 718 indicate areas of the current input video frame 702 that are relatively stable or static as compared to previous input video frames. In the example of FIG. 7, the groups of background pixel locations 718 are thus provided to step 720, where the process 700 updates the medium-term background model. The process 700 updates the medium-term background model using at least one short-term background model 722.

As discussed above, the short-term background model 722 is updated frequently, such as for example for every input video frame 702. The short-term background model 722 thus can capture the most up-to-date information for the incoming video frames, though is also susceptible to absorbing slow moving and temporarily stationary objects. Because the medium-term background model updates more slowly than the short-term background model, the medium-term background model may capture the more stable parts of the scene. Because the update step 720 updates the medium-term background model in the pixel locations indicated by the groups of background pixel locations 718, the medium-term background model updates primarily in the stable areas of the input video, and thus can be insulated from changes in the scene due to moving objects.

At step 720, to update the medium-term background model, the process 700 uses pixel values from one or more short-term background models 722, where the pixel values are taken from the pixel locations indicated by the groups of background pixel locations 718. For example, the process 700 may copy, into the medium-term background model, pixel values from the current short-term background model 722 at the pixel locations indicated by the groups of background pixel locations 718. Alternatively, the process 700 may maintain a running average (or some other cumulative value) of previous pixel values in previous short-term background models.

Once the process 700 has updated the medium-term background model at step 720, the process 700 can output an updated medium-term background model 724. Because the updated medium-term background model 724 can reflect a more stable representation of the background of a scene, a video analysis system can use the medium-term background model 724 to extract background pixels from an input video frame, such as for example in the course of blob extraction and tracking.

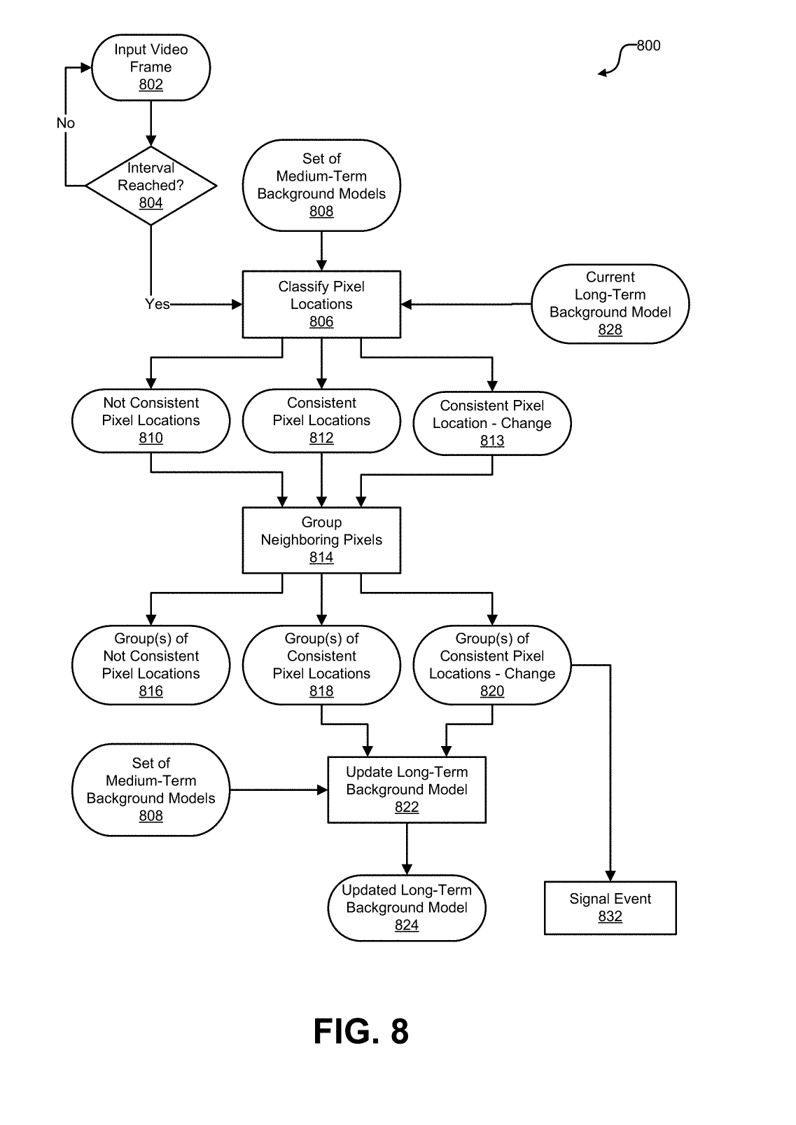

In various implementations, the medium-term background model can also be used to maintain a long-term background model. FIG. 8 illustrates an example of a process 800 for updating a long-term background model. The example process 800 can be implemented, for example, by the long-term background engine 624 of FIG. 6. The example process 800 of FIG. 8 is optional, in that the long-term background model can be updated using only the current medium-term background model, or several previous medium-term background models. For example, each time the time interval for updating the long-term background model is reached, the long-term background model can copy or accumulate (e.g., include into a running average) the pixel values from one or more medium-term background models.

The example process 800 may be triggered by the receipt of an input video frame 802. The input video frame 802 may be received by, for example, a video analysis system that includes a background modeling engine. For each input video frame 802, the process 800 may check, at step 804, whether an interval has been reached. The interval may be a count of input video frames 802 (e.g., 60, 120, 240, 480, etc. frames) and/or may be a count of seconds or fractions of a second (e.g., 4, 8, 20, 30, etc. seconds). When, at step 804, the process 800 determines that the interval has not been reached, the process 800 waits for the next input video frame 802.

When the process determines, at step 804, that the interval has been reached, the process 800 proceeds to step 806. At step 806, the process 800 can classify each pixel location in the current long-term background model 828, based on a set of medium-term background models 808. The set of medium-term background models 808 includes one or more previously-determined medium-term background models. In some implementations, the set includes the last two, three, four, eight, or some other number of medium-term background models. In some implementations, a medium-term background model is added to the set only when the process 800 executes, such that the medium-term background models in the set are not consecutive, but rather are snapshots taken at each iteration of the process 800.

Classifying the pixel locations at step 806 can include determining whether each pixel location in the current long-term background model 828 is consistent with the corresponding pixel location in each of the medium-term background models in the set of medium-term background models 808. A particular pixel location may be experiencing slow but consistent change, such as for example as the angle of the sun changes or as shadows move. Alternatively, a particular pixel location may be experiencing persistent and repetitive change, such as for example a tree moving in the wind. In these and other examples, the set of medium-term background models 808 can provide a history of the particular pixel location. The history can indicate little to no change at the particular pixel location or consistent trend of change (e.g., a gradual color change). Alternatively, the history can indicate inconsistent change, or change that does not follow a trend. Inconsistent change can indicate that, during the time span captured by the set of medium-term background models 808, foreground objects were moving in the area indicated by the particular pixel location.

Classifying pixel locations as not consistent or as consistent can enable the process 800 to selectively update the long-term background model, as well as identify long-term changes to the background. Pixel locations may be classified into at least three sets. When a pixel location does not have a history of consistent or trending change, as indicated by the set of medium-term background models 808, the pixel location is added to a set of not consistent pixel locations 810. These pixel locations identify areas where foreground objects may have been moving over the course of the video frames captured in the set of medium-term background models 808. When a pixel location has a history of consistent change, and corresponding pixel locations in the current long-term background model 828 follows the trend, the pixel location is added to a set of consistent pixel locations 812. These pixel locations indicate areas where the video frames captured by the set of medium-term background models may have not changed, or changed little from the data captured by the long-term background model. When a pixel location has a history of consistent change, but the corresponding pixel location in the current long-term background model 828 does not follow the trend, the pixel location is added to a set of consistent pixel locations with change 813. These pixel locations indicate areas where the video frames captured by the set of medium-term background models 808 have been stable, but have nonetheless changed from the data captured by the long-term background model. These pixel locations thus indicate a possible long-term change to the background of the scene.

In various implementations, instead of classifying the pixel locations at step 806, the process 800 can conduct a simplistic motion detection to identify areas of the current long-term background model 828 that should be updated. For example, the process can compare the current long-term background model 828 against the current input video frame 802, and looking for pixel locations that are different. Pixel locations in the input video frame 802 that are different from the corresponding pixel locations in the current long-term background model 828 may be different because a moving foreground object is present at the pixel location. The process 800 can thus determine that pixel locations that are different should not be updated, while pixel locations that are similar should be updated.

The classifying pixel locations step 806 examines each pixel location individually and independently. At step 814, the process 800 may group neighboring pixels among each of the not consistent pixel locations 810, the consistent pixel locations 812, and the consistent pixel locations with change 813. Grouping similar neighboring pixel locations enables the update operations of step 822 to make use of spatial correlations between neighboring pixels, such as similarity in color, gradient, and/or movement. Grouping similar neighboring pixel locations can also eliminate single or very small groups of pixel locations that have one classification and are surrounded by pixel locations of a different classification. These outlier pixel locations may be noise, encoding anomalies, or insignificantly small objects (e.g., a moving leaf). In some implementations, step 814 may include reclassifying outlier pixel locations to the same class as the surrounding pixel locations. For example, a pixel location classified as not consistent that is surrounded by pixel locations classified as consistent may be reclassified as consistent.

In various implementations, step 814 is optional, in that the update step 822 can use the not consistent pixel locations 810, consistent pixel locations 812, and consistent pixel locations with change 813 without these pixel locations being grouped. In these implementations, the process 800 can update pixel locations in the long-term background model indicated by the consistent pixel locations 812 and the consistent pixel locations with change 813, while leaving unchanged the not consistent pixel locations 810.

In the example of FIG. 8, at step 822, the process 800 updates the long-term background model using the groups of consistent pixel locations 818 and the groups of consistent pixel locations 820, which indicate areas of the long-term background model that should be updated. Areas indicated by the groups of not consistent pixel locations 816 are left unchanged in the long-term background model. In some cases, there may be no groups of not consistent pixel locations 816, such as when there were no moving foreground objects in the video frames captured in the set of medium-term background models 808. In some cases, there may be no groups of consistent pixel locations with change 820, such as when the background of the scene has not changed since the previous time the long-term background model was updated. In some cases there may be no groups of consistent pixel locations 818, such as when many moving objects obscure the scene for some time, though these cases happen infrequently.

The pixel values used to update the long-term background model can be determined from the set of medium-term background models 808. For example, the long-term background model can be updated with pixel values from the current medium-term background model, such as for example by copying the pixel values or accumulating the pixel values into a mean, median, or other cumulative value. Alternatively or additionally, at the update step 822, the process 800 can determine pixel values that follow the historical trend indicated by the set of medium-term background models. For example, when a pixel location has undergone a consistent and gradual color change, the process 800 can determine approximate pixel values that conform or naturally flow from the color change.

Once the long-term background model is updated, the process 800 can output an updated long-term background model 824. A video analytics system can use the updated long-term background model 824 to, among other things, track changes in the background. Because the short-term background model is focused on capturing data from the incoming video frames and the medium-term background model is focused on determining a stable background model, neither may be able to provide historical information about the background itself. With the long-term background model, however, the video analytics system can maintain a historical record of the background.

In some implementations, when the process 800 determines groups of consistent pixel locations with change 820, the process 800 can, at step 832, signal an event. Groups of consistent pixel locations with change 820 can indicate that the medium-term background models in the set are stable, but are different from the current long-term background model 828. This difference indicates that the background has changed since the last time the long-term background model was updated. The video analytics system can use the event signaled at step 832 to, for example, log a background change, or identify the pixel locations associated with the change (e.g., the groups of consistent pixel locations with change 820). The video analytic system can further, for example, correlate these pixel locations with blob trackers, and determine whether a blob has become stationary (e.g., a car was parked or an object was left behind), or whether a background object has become mobile (e.g., a parked car leaves the scene or an object is picked up and carried away).

In various implementations, the video analytics system can also correlate a change to the updated long-term background model 824 with a previous state of the background. For example, when a parked car leaves the scene, the video analytics system can use past long-term background models to determine that the scene has reverted to an earlier state. In some cases, the video analytics system can use the long-term background model for background subtraction in blob determination.

As noted above, background modeling may be implemented by a component of a background subtraction engine. In some implementations, the video frames provided to a background subtraction engine may be reduced in size prior to being provided to the background subtraction engine. Such reduced-size video frames can also be used by other processes in a video analytics system, such as any process that operates on an input video frame.

Reducing the size of input video frames can reduce the number of computations that may need to be executed across each video frame. For example, a reduced-size video frame can have a smaller number of image samples to process, which may reduce the storage, bandwidth, and processing requirements used during such processing. Data compression algorithms can cause a loss of information, however, which can affect the accuracy of the data processing executed by a video analytics system.

Thus, in various implementations, the video analytics system can include data reduction techniques for reducing the size of a video frame without sacrificing important details. These data reduction techniques can include adding gradient information to each input video frame and downscaling each input video frame, where the downscaling operation downscales both the color components and the gradient components. As discussed further below, the gradient information can provide a way to retain edge and texture information, and small details that would be lost in the downscaling operation.

Downscaled samples with gradient information can also be effective for modeling spatially-related variations in a scene. While a single pixel location in a video frame contains the color information for a very small part of the image, a downscaled (with gradients) sample can contain the color and gradient information for a fairly large area. For example, a single pixel that is downscaled from a 4×4 or 8×8 pixel area includes information for 16 or 64 pixels, respectively. In addition, due to spatial relationships provided by gradients, the information provided by a downscaled (with gradients) sample may be larger even that the area that was compressed into the sample. Thus, when each downscaled (with gradients) sample is applied, over time, to a statistical model, the result may model not just the statistics of a single pixel's color, but of a rather more complex structural sample of a video sequence. With such a structural sample it may be less costly to model small local variations in the background of the scene, such as moving tree branches, without losing sensitivity to moving foreground objects.

An example of the ability to model color changes over an area of a video frame can be illustrated by a scene that includes a green tree branch moving against a background of the blue sky. The tree branch may be moving in a persistent fashion, due to wind, and the motion of the tree branch may, for example, range from three to six pixels in magnitude. Such persistent motion can be included in a background model, so that the motion of the tree does not cause the tree, or parts of the tree, to be recognized as a foreground object. There may be dozens of pixels in the area of the tree branch, which may sometimes be green, sometimes be blue, or sometimes be between green and blue when at an edge, with each pixel potentially varying at different rates. Using the Gaussian Mixture Model to model these pixels may require that the video analysis system allocate many modes to model each of these color changes, so that all parts of the tree branch are not detected as foreground pixels. So many modes for so many pixels may require a large amount of data, and a large amount of additional processing to understand the relationship between the pixels.

Reducing input frames using the data reduction techniques discussed below, however, can simplify modeling the moving tree branch. For example, when the video frames are downscaled, the range of motion of the tree branch may be smaller, such as only one pixel. The pixels in the downscaled video frame may have a range of color values over time, but the range may remain in between the extremes of green and blue. Additionally, gradient information is added to the video frames before the video frames are downscaled. Since gradient information includes directional information, the direction of the gradient observed by a pixel near the boundary does not change substantially as the branch moves (though the magnitude may). This form of variation is less costly to model statistically than it is to model distinctly blue and distinctly green pixels among a larger number of pixels.

With gradient information, small moving objects can also be detected in a downscaled information. When a small moving object appears, the edges of the object may form an outline or halo around the object when the video frames are downscaled with gradient information. For example, objects as small as four to six pixels in diameter can still be detected when the input video frames are downscaled by one quarter.

FIG. 9 illustrates an example of a blob detection engine 904 that includes a frame reduction engine 920, which can implement data reduction techniques. The blob detection engine 904 can detect one or more blobs in an input video frame 902, for purposes of detecting moving objects in a scene. In various implementations, the blob detection engine 904 also includes a background subtraction engine 912, a morphology engine 914, a connected component analysis engine 916, and a blob processing engine 918. The blob detection engine 904 can output one or more blobs 908. In some cases, the blob detection engine 904 may output no blobs 908, such as when the current input video frame 902 included no foreground objects.

The frame reduction engine 920 can reduce the size of an input video frame 902, where the size is the number of bits or bytes used to represent the video frame 902. As discussed further below, in some implementations, reducing the size of the video frame 902 includes determining gradient information for the video frame 902 and downscaling the video frame 902, including downscaling both the color components and the gradient components. In various implementations, the amount by which the video frame 902 is reduced in size is configurable. For example, each video frame 902 may be reduced by a certain percentage. Alternatively or additionally, each video frame 902 may be reduced to be less than a threshold amount of data. In the latter example, individual video frames 902 may be reduced by different percentages in order to be reduced to less than the threshold amount of data.

The background subtraction engine 912 can perform background subtraction on the reduced-size video frames to detect foreground pixels. Based on the results of the background subtraction engine 912, the morphology engine 914 and connected component analysis engine 916 can perform foreground pixel processing to group the foreground pixels into foreground blobs for tracking purposes. The blob processing engine 918 can perform additional processing on the blobs generated by the connected component analysis engine 916, such as for example generating bounding boxes, performing content-based filtering of certain blobs, merging some blobs, and filtering some blobs based on size, among other things.

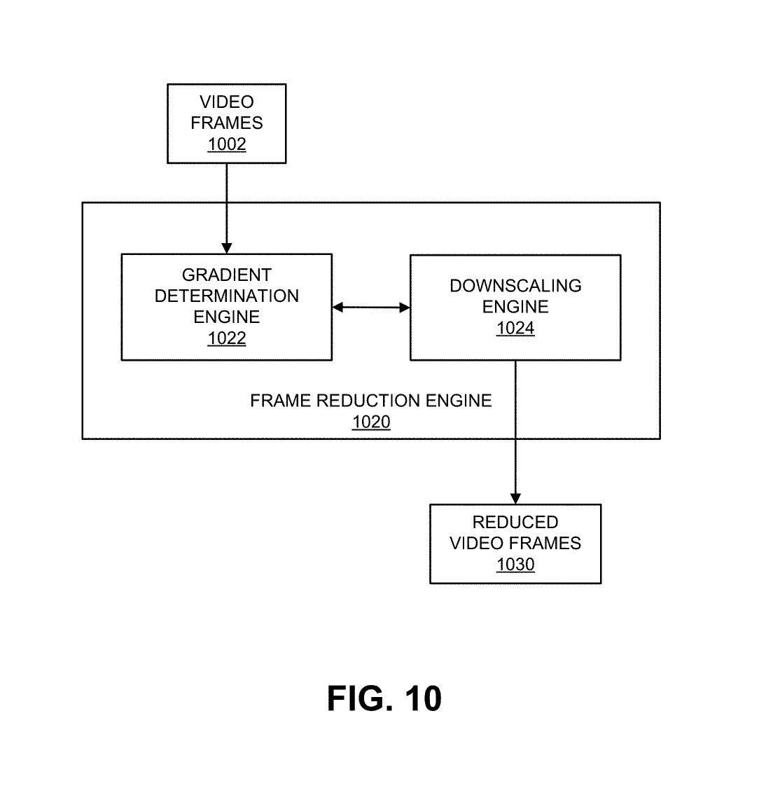

FIG. 10 illustrates an example of a frame reduction engine 1020. The example frame reduction engine 1020 includes a gradient determination engine 1022 and a downscaling engine 1024. The frame reduction engine 1020 receives video frames 1002, and can output reduced video frames 1030, which are each smaller in size (e.g., occupy fewer bytes) than their respective input video frames 1002.

The gradient determination engine 1022 can determine gradient information for each pixel in an input video frame 1002. For example, a pixel can include up to three color components, such as red, green, and blue when using an RGB color space, or luma, chroma-red, and chroma-blue when using a YUV color space. In these examples, the gradient determination engine 1022 can determine a gradient for each color component. As a result, in these examples, each pixel can include six components, three color components and three gradient components. In some implementations, each pixel can include fewer than six components, such as when each pixel was sampled at less than full resolution.

The input video frame 1002, with gradient information added, can be provided to the downscaling engine 1024. The downscaling engine 1024 can downscale the input video frame 1002 using various downscaling methods. The reduced video frames 1030 output by the frame reduction engine 1020 can be, for example, downscaled at 4-to-1 (four pixels reduced to one pixel), 16-to-1, 64-to-1, or some other ratio. In various implementations, the scale by which the input video frames are downscaled is configurable.

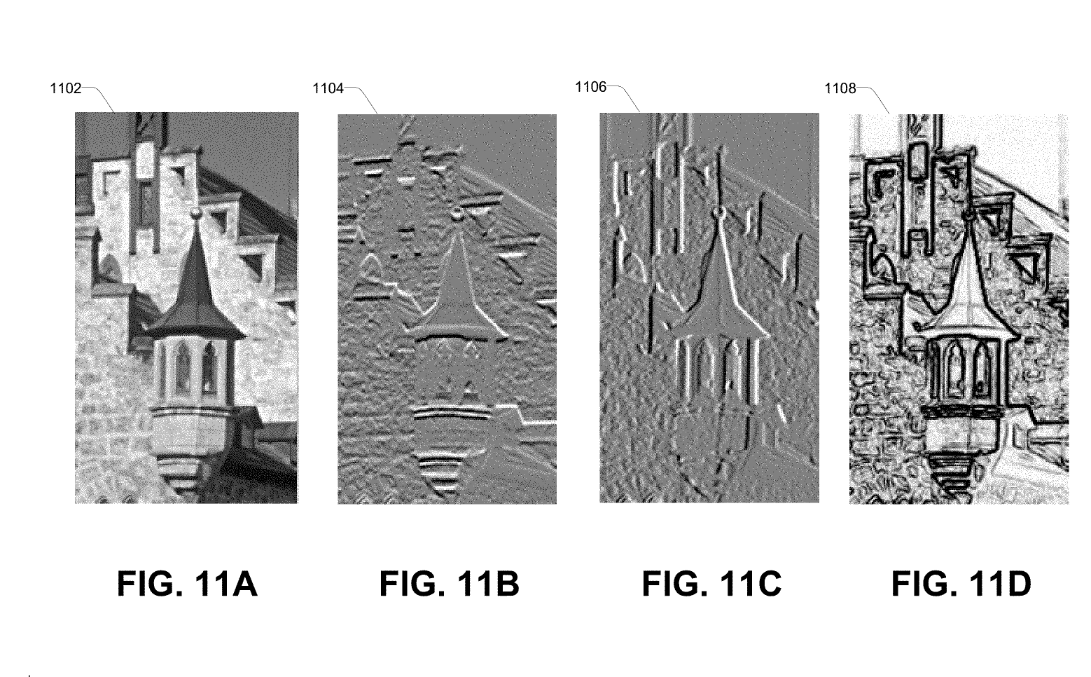

FIG. 11A-FIG. 11D illustrate an example of an image 1102 and representations of the gradient values for the image 1102. Gradients describe the intensity of the pixels in an image with respect to their neighboring pixels. Intensity can be measured by the values for each color component in a pixel, with low values indicating low intensity and high values indicating high intensity (or vice versa). For each pixel in an image, a gradient vector can indicate a direction of change, such as from low intensity to high intensity or vice versa. A magnitude can indicate the degree of change. Gradient values can be computed using, for example, a Sobel filter.

The gradient values for a pixel can be described in terms of a vertical component, a horizontal component, and a magnitude. FIG. 11A illustrates an example color image 1102. FIG. 11B illustrates an example image 1104 representing the vertical gradients for the image 1102. Areas with fairly uniform color appear flat grey. Areas where there are color changes appear as outlines, with, in this example, dark pixels indicating a vertical transition from darker to lighter, and light pixels indicating a vertical transition from lighter to darker. FIG. 11C illustrates an example image 1106 representing the horizontal gradients for the image 1102. As in FIG. 11B, in FIG. 11C uniform areas of color appear flat grey and dark and light pixels indicate horizontal transitions in color. FIG. 11D illustrates an example image 1108 representing the gradient magnitudes for the image 1102. In this example, large magnitudes are shown in darker pixels with small magnitudes being shown in lighter pixels. In FIG. 11D, it can be seen that the largest magnitudes appear at color transitions.

Various methods can be used to determine the gradient for each color component of a pixel. In one example, a gradient value can be obtained by first obtaining the horizontal, or x-gradient, and the vertical, or y-gradient, for a color component. The x-gradient and y-gradient can be obtained using, for example, a Sobel operator. Continuing the example, the x-gradient and the y-gradient can next be used in a structure tensor calculation. A structure tensor calculation, which is also referred to as a second-moment matrix, is a matrix derived from the gradient of a function. A structure tensor can be used to summarize the predominant directions of the gradient in a specified neighborhood of a point, and the degree to which those directions are coherent. In the above example, the structure tensor calculation can include computing the square of the x-gradient, the square of the y-gradient, and then the product of the results. The x-gradient and the y-gradient can further be mapped by summing each of the square of the x-gradient and the square of the y-gradient, and also taking the difference of the square of the x-gradient and the square of the y-gradient. The resulting three values—twice the product, the sum of the squares, and the difference of the squares—can further be normalized by dividing each value by a magnitude the value. The magnitude can be computing by taking the square root of the x-gradient squared plus the y-gradient squared.

Normalization can reduce the dynamic range. Reducing the dynamic range can, for example, allow a larger amount of information to be stored in a smaller number of bits. Reducing the dynamic range can also reduce the effect of a large gradient overshadowing a smaller gradient. When the gradients for a pixel location are calculated and converted to normalized values, each pixel location may have a single gradient vector, consisting of a magnitude and direction. When downscaled, since the gradients are in the structure tensor form, gradients from neighboring pixels that have a similar direction may be added together in a manner which reinforces the direction information.

When gradients in neighboring pixels do not have a similar directional vector, the summation that can occur in downscaling could ordinarily cause the weaker gradient vector to be overshadowed. For example, a few pixels may have a strong vertical (or 30-degree, or 45-degree, or some other direction) gradient, and some neighboring pixels may have a weak horizontal (or else not orthogonal) gradient. In this example, it is desirable for the downscaled image to reflect both the strong vertical and weak horizontal gradient. Normalization reduces the tendency for the smaller component to be overshadowed in the summation that can occur in downscaling. Without normalization, the smaller component may not be included in the sum.

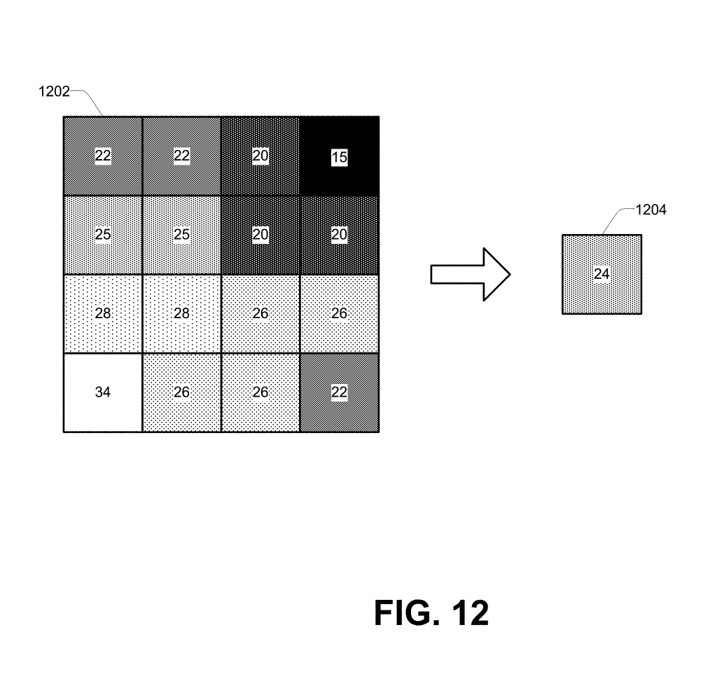

FIG. 12 illustrates a simple example of a downscaling technique. Downscaling is a process by which an image is made smaller. For example, an image that is 1920 pixels wide by 1080 pixels high can be reduced by one quarter, to an image that is 1440 pixels wide by 810 pixels high. The smaller image can be represented by a correspondingly smaller amount of data, though the smaller amount of data is not always also 25% less. Generally, downscaling techniques attempt to capture the same information in the downscaled image that is captured in the original image, for example by compressing the data for multiple pixels into one pixel. A downscaled image may be lower in quality, since the downscaled image, due to being smaller, is not able to represent the same information as the original image.

The example of FIG. 12 illustrates 16-to-1 downscaling, where sixteen original pixels 1202 are downscaled to one pixel 1204. In other examples, the downscaling can be from 4-to-1, 9-to-1, 64-to-1, or some other ratio. In the example of FIG. 12, the sixteen original pixels 1202 each include a value, which can be a color value or a gradient value. Each of the original pixels 1202 can include additional color or gradient values, which are not illustrated here for the sake of simplicity.

To produce the downscaled pixel 1204, a downscaling technique can determine a new value using the values in each of the original pixels 1202. In this illustrated example, the new value is the average of the values in the original pixels 1202. In other examples, the new value can be a median value, a largest value, a smallest value, a most common value, or some other value intended to represent all the values in the original pixels 1202. In various implementations, a downscaling technique can perform the same operation to determine each downscaled color and/or gradient value for the downscaled pixel 1204. In some implementations, a downscaling technique can use different operations to determine each color or gradient value for the downscaled pixel 1204.

Another example downscaling technique that can be used to produce the downscaled pixel 1204 is a box sum downscaling. Box sum downscaling can include applying a square box finite impulse response (FIR) filter to the image, then decimating the results. In some implementations, the FIR filter can be made larger so that each input pixel informs several outputs. In some implementations, the FIR filter can be used with both negative and positive coefficients, which can produce sharper results. In some implementations, the FIR filter can be used with only positive coefficients, to avoid potentially conflicting outcomes that may result from subtracting structure tensors. In some implementations, for uniformity, the same FIR filter can be used for gradient components and color components.

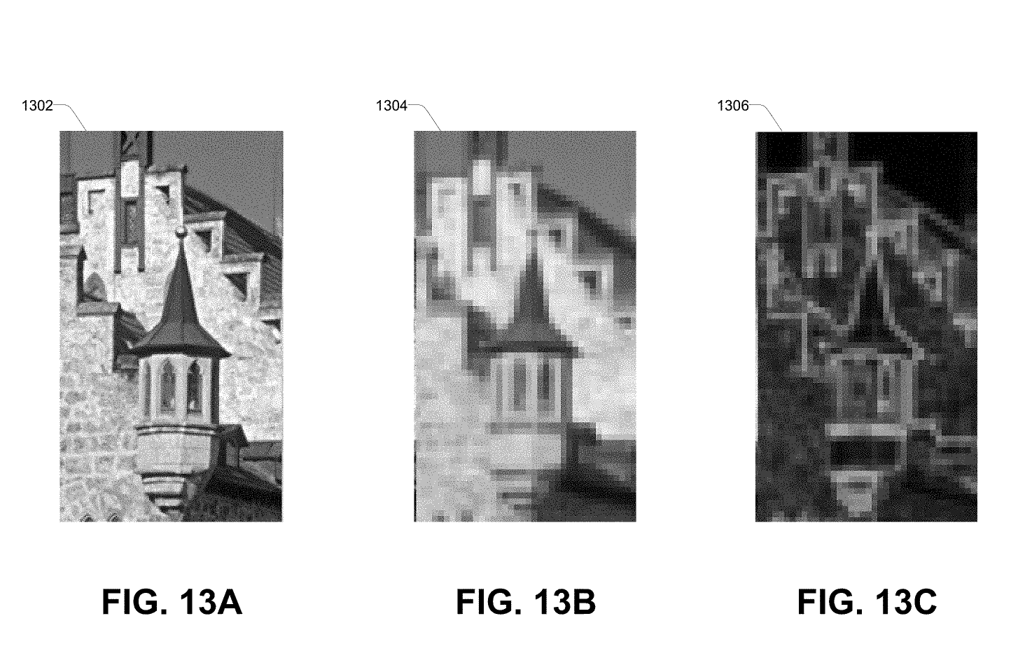

FIG. 13A-FIG. 13B illustrate the effect of downscaling an image, and the effect of gradients in a downscaled image that would result from the data reduction techniques discussed above. FIG. 13A illustrates an example color image 1302. FIG. 13B illustrates an example image 1304 that results from downscaling the original image 1302 by one quarter. The downscaled image 1304 would ordinarily be 25% smaller in the horizontal and vertical directions than the original image, but has been enlarged in this example (using pixel replication) to make the downscaled image 1304 have the same width and height as the original image 1302. In this example, the downscaling computations were conducted in YUV space, and the resulting downscaled image 1304 was converted to RGB for display.

As illustrated by FIG. 13B, edges in the downscaled image 1304 are “blurry” or indistinct. Fine details, such as the texture of the wall, and small objects, such as the ball on top of the tower, are also less distinct in the downscaled image 1304. Similarly, edges, such as the horizontal lines below the windows, are nearly blurred into the surrounding colors. Such loss of detail can be problematic in accurately determining a background model and determining moving objects, among other things.

Adding gradient information to the original image 1302 prior to downscaling the image can preserve some of the important details in the original image 1302. FIG. 13C illustrates a gradient image 1306, which provides a representation of the gradient planes for the original image 1302, after the gradient planes have been downscaled. In this representation, three gradient image planes (one for each color component) were treated as YUV values, downscaled in the same way as the color values, and converted to RGB for display. The resulting image was also enlarged to have the same horizontal and vertical sizes as the original image 1302. The resulting gradient image 1306 provides a false color display for the gradient planes. In this example, hue represents direction: horizontal gradients are represented in yellow, and vertical gradients are represented in blue.

While edges, textures, and small features are blurry on the downscaled image 1304, these details have a strong representation in the gradient image 1306. Edges, for example, are one or more pixels wide and have a consistent hue. For example, the horizontal lines below the windows that are indistinct in the downscaled image 1304 appear as strong green lines in the gradient image 1306. Similarly, the ball at the top of the tower appears as a variety of bright colors representing edges in different directions. The texture of the wall is also preserved in the gradient image 1306, appearing as speckles, in contrast to less textured areas, which appear mostly black.

Adding gradient information to an image and downscaling the image can also make small and persistent movements, such as the movement of trees, in the background easier to model. When an object moves, for example, thirteen pixels in the original image, the object's movement will be, for example, only three and a quarter pixels in the downscaled (with gradients) image. In other words, small changes may not produce large differences that may need to be incorporated into, for example, a background model. Large changes, on the other hand can be recognized as foreground objects that should not be incorporated into the background model. Spatial correlation between similar neighboring pixels can further help a video analysis system to recognize a small moving object as part of a larger, stationary object. Spatial correlations are preserved, to some degree, by the combination of multiple pixels into fewer pixels that occurs in a downscaling operation.

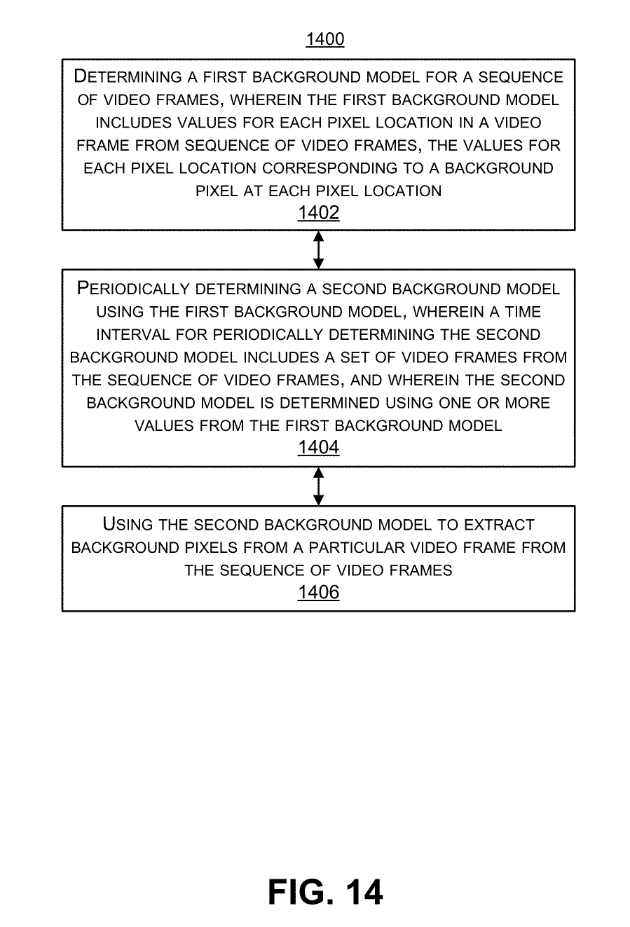

FIG. 14 illustrates an example of a process 1400 for the cascaded-time-scale background modeling techniques described herein. At step 1402, the process 1400 includes determining a first background model for a sequence of video frames, wherein the first background model includes values for each pixel location in a video frame from the sequence of video frames, the values for each pixel location corresponding to a background pixel at each pixel location. In various implementations, the first background model can be determined for each video frame in the sequence of video frame. In these implementations, the first background model can update quickly, so that the first background model can include changes to the background of a scene. In some cases, however, the first background model may be updating so quickly that moving objects that are briefly stationary may be absorbed into the first background model.

In various implementations, the values included in the first background model are cumulative values for pixels found at each pixel location in each video frame from the sequence of video frames. A cumulative value can be, for example, a mean, a median, a largest value, a smallest value, a most common value, or some other cumulative value. In various implementations, the first background model can include a cumulative value for each color component in a pixel. In some implementations, the first background model can also include a cumulative value for gradient components for a pixel.

At 1404, the process 1400 includes periodically determining a second background model using the first background model, wherein a time interval for periodically determining the second background model includes a set of video frames from the sequence of video frames, and wherein the second background model is determined using one or more values from the first background model. The second background model can update slower than that the first background model, and thus be less likely to absorb temporarily stationary objects. In various implementations, the second background model can be updated once every half second, once every second, once for every ten video frames from the sequence of video frames, once for every thirty video frames, or once per some other time interval, measured in some other fashion.

In various implementations, the second background model uses the first background model to update the values in the second background model. For example, the second background model can include cumulative values for each pixel location, and when updating, values from the first background model can be included in the cumulative values in the second background model. Alternatively, the second background model can copy values from the current first background model.

In some implementations, determining the second background model can include using the second background model to identify foreground pixel locations and background pixel locations in a current video frame. For example, each pixel location in the second background model can be compared to a corresponding pixel location in the video frame that is current when the second background model is being updated. In this example, when a difference between the values at the pixel locations is greater than a difference threshold, the pixel location can be designated a foreground pixel location, while other pixel locations can be designated as background pixel locations In these implementations, the second background model can be updated in pixel locations designated as background locations.

At 1406, the process 1400 includes using the second background model to extract background pixels from a particular video frame from the sequence of video frames. Extracting the background pixels can further identify foreground pixels in the particular video frame. The foreground pixels can further be processed into blobs, and be used for tracking objects moving in the scene.

In some examples, the process 1400 may be performed by a computing device or an apparatus, such as the video analytics system 100. For example, the process 1400 can be performed by the video analytics system 100 and/or the object tracking engine 106 shown in FIG. 1. In some cases, the computing device or apparatus may include a processor, microprocessor, microcomputer, or other component of a device that is configured to carry out the steps of process 1400. In some examples, the computing device or apparatus may include a camera configured to capture video data (e.g., a video sequence) including video frames. For example, the computing device may include a camera device (e.g., an IP camera or other type of camera device) that may include a video codec. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Process 1400 is illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The content-adaptive blob tracking operations discussed herein may be implemented using compressed video or using uncompressed video frames (before or after compression). An example video encoding and decoding system includes a source device that provides encoded video data to be decoded at a later time by a destination device. In particular, the source device provides the video data to the destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming devices, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by the source device. The destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. The destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, the system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of the source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above is merely one example. Techniques for processing video data in parallel may be performed by any digital video encoding and/or decoding device.

Although generally the techniques of this disclosure are performed by a video encoding device, the techniques may also be performed by a video encoder/decoder, typically referred to as a “CODEC.” Moreover, the techniques of this disclosure may also be performed by a video preprocessor. The source device and the destination device are merely examples of such coding devices in which the source device generates coded video data for transmission to the destination device. In some examples, the source and destination devices may operate in a substantially symmetrical manner such that each of the devices includes video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if the video source is a video camera, the source device and the destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

In the foregoing description, aspects of the application are described with reference to specific embodiments thereof, but those skilled in the art will recognize that the invention is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete, but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method for background modeling, comprising:
determining a first background model for a sequence of video frames, wherein the first background model includes values for a background pixel at each pixel location in a video frame from the sequence of video frames;
periodically determining a second background model using the first background model, wherein a time interval for periodically determining the second background model includes a set of video frames from the sequence of video frames; and
using the second background model to extract background pixels from a particular video frame from the sequence of video frames.

2. The method of claim 1, further comprising:
periodically determining a third background model using a set of the second background model, the set of the second background model including the second background model and one or more previous second background models, and wherein a second time interval for periodically determining the third background model includes a second set of video frames from the sequence of video frames, the second set being larger than the set of video frames.

3. The method of claim 2, wherein determining the third background model includes:
determining, using the set of the second background model, a change status for each pixel location in the third background model, wherein, when a degree of change at a pixel location is less than a change threshold, the change status is set to a first value, and wherein, when the degree of change at a pixel location is equal to or greater than the change threshold, the change status is set to a second value; and
updating the third background model using the set of the second background model, wherein the third background model is updated using values determined from the set of the second model that correspond to pixel locations having a change status set to the first value.

4. The method of claim 2, further comprising:
determining, using the set of the second background model, a change status for each pixel location in the third background model, wherein, when a degree of change at a pixel location is less than a change threshold, the change status is set to a first value, and wherein, when the degree of change at a pixel location is equal to or greater the change threshold, the change status is set to a second value; and
comparing pixel locations in a current second background model against corresponding pixel locations in the third background model, wherein the compared pixel locations have a change status set to the first value;
determining, using a result of the comparing, that one or more pixel locations vary between the current background model and the third background model by an amount exceeding a similarity threshold; and
signaling a change in the third background model.

5. The method of claim 1, further comprising:
reducing a size of a video frame from the sequence of video frames; and
using the reduced-size video frame to determine the first background model.

6. The method of claim 5, wherein reducing the size of the video frame includes:
determining gradient information for the video frame; and
downscaling the video frame.

7. An apparatus, comprising:
a memory configured to store video data, and
a processor configured to:
determine a first background model for a sequence of video frames, wherein the first background model includes values for a background pixel for each pixel location in a video frame from the sequence of video frames;
periodically determine a second background model using the first background model, wherein a time interval for periodically determining the second background model includes a set of video frames from the sequence of video frames; and
use the second background model to extract background pixels from a particular video frame from the sequence of video frames.

8. The apparatus of claim 7, wherein determining the second background model includes:
upon expiration of the time interval, using the second background model to identify foreground pixel locations and background pixel locations in a current video frame; and
updating the second background model using the identified background pixel locations, wherein the second background model is updated with values from the first background model that correspond to the background pixel locations.

9. The apparatus of claim 8, wherein identifying the foreground pixel locations and the background pixel locations includes:
comparing values in the second background model against pixels in the current video frame, wherein the foreground pixel locations include locations in the current video frame where a result of the comparing is equal to or greater than a difference threshold, and wherein the background pixel locations include locations in the current video frame where the result of the comparing is less than the difference threshold.

10. The apparatus of claim 7, wherein the processor is further configured to:
periodically determine a third background model using a set of the second background model, the set of the second background model including the second background model and one or more previous second background models, wherein a second time interval for periodically determining the third background model includes a second set of video frames from the sequence of video frames, the second set being larger than the set of video frames, and wherein the third background model is determined using values determined from the set of the second background model.

11. The apparatus of claim 10, wherein determining the third background model includes:
upon expiration of the second time interval, using the third background model to identify foreground pixel locations and background pixel locations in a current video frame; and
updating the third background model using the identified background pixel locations, wherein the third background model is updated with values determined from the set of the second background model, wherein the values are determined for locations that correspond to the background pixel locations.

12. The apparatus of claim 10, wherein determining the third background model includes:
determining, using the set of the second background model, a change status for each pixel location in the third background model, wherein, when a degree of change at a pixel location is less than a change threshold, the change status is set to a first value, and wherein, when the degree of change at a pixel location is equal to or greater than the change threshold, the change status is set to a second value; and
updating the third background model using the set of the second background model, wherein the third background model is updated using values determined from the set of the second model that correspond to pixel locations having a change status set to the first value.

13. The apparatus of claim 12, wherein determining the third background model includes:
grouping neighboring pixel locations that have a same change status; and
resetting the change status for ungrouped pixel locations, wherein ungrouped pixel locations having a change status set to the first value are reset to having a change status set to the second value, and wherein ungrouped pixel locations having a change status set to the second value are reset to having a change status set to the first value.

14. The apparatus of claim 10, wherein determining the third background model includes:
determining, using the set of the second background model, a change status for each pixel location in the third background model, wherein, when a degree of change at a pixel location is less than a change threshold, the change status is set to a first value, and wherein, when the degree of change at a pixel location is equal to or greater the change threshold, the change status is set to a second value; and
determining to not update the third background model at pixel locations having a change status set to the second value.

15. The apparatus of claim 10, wherein the processor is further configured to:
determine, using the set of the second background model, a change status for each pixel location in the third background model, wherein, when a degree of change at a pixel location is less than a change threshold, the change status is set to a first value, and wherein, when the degree of change at a pixel location is equal to or greater the change threshold, the change status is set to a second value; and
compare pixel locations in a current second background model against corresponding pixel locations in the third background model, wherein the compared pixel locations have a change status set to the first value;
determine, using a result of the comparing, that one or more pixel locations vary between the current background model and the third background model by an amount exceeding a similarity threshold; and
signaling a change in the third background model.

16. The apparatus of claim 7, wherein the processor is further configured to:
reduce a size of a video frame from the sequence of video frames; and
use the reduced-size video frame to determine the first background model.

17. The apparatus of claim 16, wherein reducing the size of the video frame includes:
determining gradient information for the video frame; and
downscaling the video frame.

18. A computer-readable medium having stored thereon instructions that, when executed by a processor, perform a method, the method including:
determining a first background model for a sequence of video frames, wherein the first background model includes values a background pixel for each pixel location in a video frame from the sequence of video frames;
periodically determining a second background model using the first background model, wherein a time interval for periodically determining the second background model includes a set of video frames from the sequence of video frames; and
using the second background model to extract background pixels from a particular video frame from the sequence of video frames.

19. The computer-readable medium of claim 18, wherein the method further includes:
periodically determining a third background model using a set of the second background model, the set of the second background model including the second background model and one or more previous second background models, wherein a second time interval for periodically determining the third background model includes a second set of video frames from the sequence of video frames, the second set being larger than the set of video frames, and wherein the third background model is determined using values determined from the set of the second background model

20. The computer-readable medium of claim 19, wherein the method further includes:
determining, using the set of the second background model, a change status for each pixel location in the third background model, wherein, when a degree of change at a pixel location is less than a change threshold, the change status is set to a first value, and wherein, when the degree of change at a pixel location is equal to or greater the change threshold, the change status is set to a second value; and
comparing pixel locations in a current second background model against corresponding pixel locations in the third background model, wherein the compared pixel locations have a change status set to the first value;
determining, using a result of the comparing, that one or more pixel locations vary between the current background model and the third background model by an amount exceeding a similarity threshold; and
signaling a change in the third background model.
